(19) United States
(12) Patent Application Publication
(10) Pub. No.: US 2004/0230411 A1
(43) Pub. Date: Nov. 18, 2004

(54) Apparatus and methods for predicting properties of processed material

(75) Inventors: Rong Zheng, Forest Hill (AU); Peter Kennedy, Elwood (AU); Roger Tanner, Roseville (AU)

Correspondence Address: TESTA, HURWITZ & THIBEAULT, LLP, HIGH STREET TOWER, 125 HIGH STREET, BOSTON, MA, 02110, US

(73) Assignee: Moldflow Ireland Ltd., Blackrock, Cork (IE)

(21) Appl. No.: 10/791,218

(22) Filed: Mar. 2, 2004

Related U.S. Application Data
(60) Provisional application No. 60/451,825, filed on Mar. 3, 2003.

(51) Int. Cl. G06F 19/00

(52) U.S. Cl. 703/6; 700/97; 703/2

(57) ABSTRACT

The invention provides an apparatus and methods for predicting properties of processed material by simulating the processing history of the material, by using a two-phase constitutive description of the material to characterize the morphology of the material as it is being processed, and by using this morphological characterization to predict values of properties of the material at any stage of processing. The property values may be used in a structural analysis of the processed part, in the design of the part, and/or in the design of the process for manufacturing the part.

### PRIOR APPLICATIONS

This application claims the benefit of U.S. Provisional Patent Application No. 60/451,825, filed Mar. 3, 2003, which is hereby incorporated by reference in its entirety.

### FIELD OF THE INVENTION

This invention relates generally to the field of plastics processing. More particularly, in certain embodiments, the invention relates to techniques for designing, testing, and manufacturing components.

### BACKGROUND OF THE INVENTION

It is helpful in the design and manufacture of polymer-containing products to predict how well the product will perform in actual use. Product performance may be evaluated using a computer-based structural analysis technique to predict how a product will react under various support conditions, loads, and other inputs. Structural analysis may also be used to predict the warpage of a plastic component after processing due to residual stresses within the component. Other structural analysis techniques evaluate crack propagation, creep, wear, and/or other aging phenomena that occur during the lifetime of a manufactured product.

Computer models have been developed for performing structural analyses of various kinds of products. A structural analysis constitutive model may include a finite element mesh that defines a solution domain in which constitutive equations are solved, subject to specified support conditions, loads, and/or imposed forces. Alternatively, a structural analysis constitutive model, as the term is used herein, may be one or more empirical or semi-empirical correlations between (1) one or more properties of a material from which a manufactured part or product is made, and (2) an experimentally-observed characteristic of the part/product. For example, a structural analysis constitutive model may be an empirical relationship between (1) tensile properties of material from which a plastic support is manufactured, and (2) the maximum load that can be borne by the plastic support.

Structural analysis of a product generally requires a description of the material(s) of which the product is composed. This description may be provided as a set of experimentally-determined material properties that are used as inputs in a structural analysis constitutive model. Structural analysis models often require rheological properties as inputs. Certain rheological properties of polymeric materials vary considerably with temperature and/or imposed shear, and these dependencies must be adequately accounted for in structural analysis constitutive models.

Various kinds of laboratory tests are currently performed to quantify rheological properties of polymeric materials. These laboratory tests include, for example, tensile tests, cure-response tests, oscillatory shear tests, flow birefringence tests, swell and shrinkage tests, and various viscometric tests. The laboratory samples used in these tests are generally manufactured differently than the actual product for which structural analysis is to be performed. For example, the laboratory samples may be strips of material cut or formed specifically for use with a laboratory tensile testing machine. Although the process of creating the laboratory samples may be similar to the process for creating the final product, there are usually unavoidable differences between the processes owing, at least in part, to a difference between the shape and size of the laboratory samples and the shape and size of the final part/product. As a result, laboratory samples generally do not have the same morphology as the final product for which structural analysis is desired.

Consequently, a product designer may attempt to determine how material properties vary over a range of process histories and/or compositions by conducting experiments with full-sized plastic part samples produced under different processing conditions and/or with different raw material compositions. This is usually impractical, due to the large number of fall-size samples that would be required to cover even a small range of process histories and/or compositions. It may be impossible to obtain certain rheological property measurements using only full-size product/part samples, since most traditional rheological tests require the use of a sample that contains a non-negligible amount of material formed into a given shape. Furthermore, material properties may vary throughout a given plastic part due to material inhomogeneity. It is often impractical or impossible to experimentally quantify the inhomogeneity of material properties within a given plastic part.

Process models may be used to predict temperature, flow velocity, flow direction, pressure, and/or other variables observed throughout a given process. However, current process models generally do not offer a satisfactory description of material morphology resulting from a given process, since the models do not track changes in the microstructure of the processed material.

The prediction of crystallinity has been investigated as a means of describing the morphology of polymeric material. However, previous methods of describing crystallization kinetics of polymeric materials do not adequately account for the effect of flow on crystallization.

The use of inadequate structural analysis constitutive models leads to the need for high safety factors, the use of too much material, and/or the poor prediction of product/part performance in the manufacture and analysis of plastic parts. Thus, there is a need for a method of accurately predicting properties of a material as it is processed to form a manufactured product, such that those properties may be accurately used in the structural analysis of the ultimate product.

### SUMMARY OF THE INVENTION

The invention provides an apparatus and methods for predicting properties of processed material in the manufacture of a product or component/part of arbitrary geometry. These predicted properties are particularly well-suited for use as inputs in a structural analysis constitutive model of the product/part. Accordingly, the invention also provides an apparatus and methods for structural analysis of a manufactured component/part using these predicted properties.

The improved structural analysis leads to an improved method of designing any of a wide range of products and/or manufacturing processes. Thus, the invention also provides an apparatus and methods for designing a product/part and for designing a process for manufacturing the product/part.

The performance characteristics of a manufactured product typically depend not only on the intrinsic properties of the product's raw material(s), but also on the effect that processing has had during the manufacture of the product upon the morphology of the material. The morphology of polymeric material varies depending on how the material is processed, and the morphology affects the overall performance characteristics of the final product. This is particularly true in processes such as injection molding where a material phase change occurs during the process. For example, the way that molten polymer flows into a mold during the filling phase of an injection molding process and the way the polymer behaves during packing and cooling may affect the ultimate structural properties of the molded part. Thus, structural analysis constitutive models which use only intrinsic material properties as inputs do not adequately account for processing effects and may yield inaccurate predictions of part performance. The invention provides methods for predicting material properties that adequately account for processing effects.

More specifically, the invention provides methods of predicting material properties of processed material by combining a process model with a multiphase micromechanical model in order to adequately account for the way process conditions affect the morphology (and, hence, properties) of the material throughout a given manufacturing process.

Processing often has a dramatic effect on the mechanical, thermal, and optical properties of processed material, particularly where a material phase change occurs during the process. The invention provides methods of simulating the processing history of a material and predicting the resulting morphology of the material at any stage of processing by employing a two-phase model of the crystallizing material. The morphology of the material can be characterized after each of a series of time steps in a process model, and the morphological characterization used, in turn, to predict properties of the material as it is being processed. These properties can then be used as inputs in a structural analysis constitutive model, or in any other product performance analysis technique. Material properties predicted according to methods of the invention include, for example, rheological properties, such as elastic modulus, dynamic modulus, viscosity, impact strength, compressive strength, flexural strength, and tensile strength.

According to certain embodiments of the invention, one or more of these predicted properties are used in a structural analysis constitutive model. Structural analysis constitutive models are typically computer-based models that are used to predict how a part will react to support conditions, loads, and/or other input forces. Structural analysis constitutive models used in embodiments of the invention include, for example, dynamic mechanical analysis (DMA) models and mechanical event simulations (MES). In addition to mechanical simulation, structural analysis constitutive models of the invention include simulations of the temperature-time history experienced by a manufactured part (i.e. thermal loading) to predict how the part will respond over time. Structural analysis constitutive models are used, for example, to predict warpage, crack propagation, creep, wear, failure, and/or aging phenomena of a manufactured part.

Methods of the invention improve the accuracy of the analysis of a manufactured part by accounting for processing effects in the prediction of part performance. Accurate prediction of the performance of a manufactured part allows improved development and design of plastic parts and the processes for making them.

The invention provides an improvement in the virtual prototyping of plastic products by accurately accounting for processing effects. Preferred embodiments of the invention include a description of the crystallization of material during one or more stages of processing. In one embodiment, the invention accounts for the effect of flow on crystallization, for example, by modeling the rate at which material crystallizes from one phase to another as a function of flow kinematics. The crystallization kinetics are defined in terms of an expression for the change in free energy of the crystallizing, flowing material. A relative crystallinity is determined at each of a series of time steps during a given process according to a characterization of the flow, where the flow characterization is determined from a process model. Flow-induced stresses of the two phases of the crystallizing material are computed from the flow characterization using a micromechanical representation of each phase, and a total flow-induced stress of the material is determined at each time step according to the relative amounts of each phase (the relative crystallinity) at that time step. Expressions for the conformation of micromechanical elements in each phase of the material may be used in addition to or in place of expressions for flow-induced stress. Viscosity and specific volume of the material are updated according to the relative crystallinity and may be fed back as inputs in the process model to determine the kinematics at the next time step. Thus, the relative crystallinity, flow-induced stress, viscosity, and/or specific volume are re-computed for the new time step according to the kinematics at the previous time step, and the process continues until the time corresponds to the end of the processing, or, alternatively, at any time during the processing at which it is desired to predict a value of a property of the material from the morphological characterization. Thus, the invention allows a user to obtain a snapshot of a distribution of a property of processed material, such as elastic modulus and/or complex modulus, at a specific moment during or after processing, for use in a structural analysis constitutive model of the manufactured part. The invention also allows a user to track the distribution of a property of processed material, such as elastic modulus and/or complex modulus, throughout processing, as well as at some future time, accounting for the time-temperature and/or flow history experienced by the material. Furthermore, the invention provides structural analysis constitutive models that use input properties provided thusly.

In one embodiment, the method for predicting a material property for use in structural analysis includes simulating the filling, packing, and post-molding stages of an injection molding process, for example, to determine the kinematics (velocity field, pressure field) and temperature of the flowing polymeric material throughout the process. The kinematics are used as inputs in a viscoelastic constitutive model to predict the stress and/or conformation of the material at any time throughout its processing history. A morphological characterization of the material is obtained, wherein the material is modeled as a composite of an amorphous phase and a crystalline, or, more preferably, semi-crystalline phase. The semi-crystalline phase may be represented as comprising crystals having inclusions of amorphous material.

The morphological characterization of the flowing polymeric material includes a description of the orientation of molecules in each of its phases and accounts for the rate at which the material changes from one phase to the other (i.e. the crystallization kinetics). A preferred embodiment of the invention uses an expression for the flow-induced change in free energy to account for the effect of stress due to flow on the crystallization rate of the material.

By way of example, the morphological characterization of the material obtained in one embodiment of the invention includes at least a subset of the following information as a function of time throughout a simulation of any number of stages (i.e. unit operations) of a manufacturing process: the degree of crystallization of the material (i.e. relative crystallinity); the orientation of the semi-crystalline and/or amorphous phases (i.e. orientation tensor and/or conformation tensor); the size and shape distributions of the crystallites; and the crystal volume.

In one embodiment, the invention uses experimentally-determined or estimated values of modulus of the amorphous phase and the semi-crystalline phase of a material, along with a morphological characterization of the material, in order to predict values of properties of the processed material as it crystallizes. Predicted values of properties may include one or more components of the elastic moduli tensor of the processed material, for example, longitudinal transverse Young's modulus, in-plane or out-plane shear modulus, or plane-strain bulk modulus. The estimated property values may then be used in a structural analysis constitutive model, for example, to assess the performance of the molded part, to design the part, and/or to optimize process conditions for producing the part.

The invention also permits the estimation of any property that is derivable from a knowledge of the morphology of the material. Since the morphology of the material can be predicted at any stage of a given process, processing conditions can be varied and resulting material properties predicted in order to optimize the design of a manufacturing process. Similarly, the design of a part may be varied and resulting material properties predicted in order to optimize the design of the part.

An important industrial problem that can be solved using one embodiment of the invention is the post-molding warpage of injection-molded parts. Frequently, parts that are dimensionally correct when molded will deform when subjected to elevated or reduced temperatures. The relaxation of the residual stresses in the part and changes in the thermo-mechanical properties of the material as the part is heated and/or cooled contribute to this deformation. The invention allows the prediction of the relaxation behavior and thermo-mechanical properties of a manufactured part, and allows their use in determining the post-molding deformation and/or shrinkage of the part.

In one aspect, the invention relates to a method for predicting a value of a property of processed material, where the method includes the steps of providing a process description including one or more governing equations; obtaining a characterization of a flow of a material using the process description; obtaining a morphological characterization of the material using the flow characterization; and predicting a value of a property of the material using the morphological characterization.

In one embodiment, the material being processed is a polymeric material, which may or may not include one or more crosslinking agents, fillers (such as glass fibers or talc), colorants, antioxidants, wax, petroleum products, and/or other substances. In one embodiment, the material is a thermoplastic. In one embodiment, the material comprises rubber.

The process description may be a model of an injection molding process, an extrusion process, a vacuum forming process, a spinning process, a curing process, a blow molding process, or a combination of these processes, for example. Extrusion includes, for example, profile extrusion, blow film extrusion, and film extrusion. The modeled process may be a multistage process. For example, the invention may use a model of an injection molding process including descriptions of filling, packing, and post-molding (i.e. cooling) stages. The process model includes one or more governing equations—for example, conservation of mass, conservation of momentum, and conservation of energy equations.

The invention provides methods for predicting rheological properties, mechanical properties, thermal properties, and optical properties. Material properties that can be predicted include viscosity, density, specific volume, stress, elastic modulus, dynamic viscosity, and complex modulus. One or more components of an elastic moduli tensor and/or stress tensor can be determined. Elastic modulus includes, for example, longitudinal and transverse Young's modulus, in-plane and out-plane shear modulus, and plane-strain bulk modulus. Stress includes, for example, flow-induced stress (extra stress, deviatoric stress), thermally and pressure-induced stress, and viscous stress. For example, the residual stress distribution in the part due to flow-induced stress can be determined, as well as the distribution of thermomechanical stresses, during and/or after each stage of a given process. Furthermore, methods of the invention provide for prediction of impact strength, mode of failure, mode of ductile failure, mode of brittle failure, failure stress, failure strain, failure modulus, failure flexural modulus, failure tensile modulus, other failure criterion, stiffness, maximum loading, burst strength, thermal coefficient of expansion, thermal conductivity, clarity, opaqueness, surface gloss, color variation, birefringence, or refractive index.

Preferred methods of the invention include the step of obtaining a morphological characterization of the material as a function of its flow kinematics during material processing. In one embodiment, the morphological characterization includes one or more components of a conformation tensor, one or more components of an orientation tensor, a crystallinity, and/or a relative crystallinity. Alternatively to (or in addition to) tensor components, the morphological characterization may be made up of vector components and/or scalar values describing conformation and/or orientation.

In one embodiment, the step of obtaining a morphological characterization involves using a description of crystallization kinetics. Preferably, the description is a crystallization kinetics model that includes a description of a flow-induced free energy change, a description of flow-enhanced nucleation, and/or a dimensionality exponent. In one embodiment, the dimensionality exponent is expressed as a function of a second-order orientation tensor, and/or is obtained using a micromechanical model of a semi-crystalline phase subjected to a given flow field. For example, the dimensionality exponent may be a modified Avrami index.

In one embodiment, the method of predicting a value of a property of processed material includes using a two-phase description of the material to obtain a morphological characterization of the material. For example, the two-phase description includes an amorphous phase model, a semi-crystalline phase model, and a crystallization kinetics model, where the crystallization kinetics model describes the transformation of material from one phase to the other. In one embodiment, the two-phase model includes a viscoelastic constitutive equation that describes an amorphous phase. In one embodiment, the amorphous phase model is a FENE-P (finite extensible non-linear elastic model with a Peterlin closure approximation) dumbbell model, an extended POM-POM model, a POM-POM model, a Giesekus model, and/or a Phan-Thien Tanner model. In one embodiment, the two-phase description includes a rigid dumbbell model that describes a semi-crystalline phase. In an alternative embodiment, more than two phases are modeled, for example, three, four, five, or more phases may be modeled. The crystallization kinetics model can be any kinetic model that describes a change of phase and/or change of state in systems having two, three, four, five, or more phases and/or states of matter.

In one embodiment, the method of predicting a value of a property of processed material further includes the step of performing a structural analysis of a product or part made from the processed material, using the predicted value of the material property. The structural analysis may be a warpage analysis and/or a shrinkage analysis of the product/part, or it may predict how the product/part reacts to a force, such as a load or other imposed force. The structural analysis may be an evaluation of crack propagation, creep, and/or wear. Other example structural analyses suitable for use with the invention include analyses to determine impact strength, stiffness, hysteresis, rolling resistance, and failure properties such as mode of failure, mode of ductile failure, mode of brittle failure, failure stress, failure modulus, failure tensile modulus, maximum loading, and burst strength.

In one embodiment, the characterization of flow used in the method of predicting the value of a property of processed material includes the use of a dual domain solution method as in co-owned U.S. Pat. No. 6,096,088, issued to Yu et al., the specification of which is incorporated herein by reference in its entirety. In one embodiment, the characterization of flow includes the use of a hybrid solution method as in co-owned U.S. patent application Ser. No. 10/771,739, by Yu et al., the specification of which is incorporated herein by reference in its entirety. These methods allow for simplification of the numerical solution methods, freeing up computational resources for use in other steps of the method of predicting processed material property values. In one embodiment, one or more of the flow characterization, the morphological characterization, and the value of the material property are obtained after each of a series of time steps in the solution of the process model. Where applicable, the dual domain and hybrid solution methods allow greatly improved computational efficiency in this step-wise solution procedure.

In one embodiment, crystallization experiments are performed to determine one or more parameters used in obtaining the morphological characterization. Crystallization experiments may be performed to determine a crystal growth rate of the material under quiescent conditions and/or a half-crystallization time. Experiments may also be performed to determine a relaxation spectrum and/or a time-temperature shift factor.

In another aspect, the invention includes a method for performing a structural analysis of a manufactured part, the method including the steps of: providing a description of a process used in manufacturing a part, wherein the description includes at least one governing equation; obtaining a characterization of flow of a material using the process description; obtaining a morphological characterization of the material using the characterization of flow of the material; predicting a value of a property of the material using the morphological characterization; and performing a structural analysis of the part using the predicted value of the property. In one embodiment, the step of performing a structural analysis includes creating a structural analysis constitutive model. In one embodiment, the step of performing a structural analysis includes predicting the response of the part to a load. In one embodiment, the step of performing a structural analysis includes predicting warpage, shrinkage, crack propagation, hysteresis, rolling resistance, creep, wear, lifetime, and/or failure of the part.

In another aspect, the invention provides a method for designing a part, which includes the steps of: providing a test design of a part, where the part is made from a given material; providing a mathematical process description using one or more governing equations applied within a volume, where the volume is based on the test design of the part; obtaining a characterization of a flow of the material using the process description; obtaining a morphological characterization of the material using the flow characterization; predicting a value of a property of the material using the morphological characterization; using the value of the property to evaluate a measure of part performance; and determining whether the measure of part performance satisfies a predetermined criterion. In one embodiment, the method further includes the step of modifying the test design in the event that the measure of part performance does not satisfy the predetermined criterion. The criterion for the measure of part performance may be, for example, a minimum, maximum, or acceptable range of strength, modulus, hysteresis, rolling resistance, or a failure property.

In another aspect, the invention includes a method for designing a manufacturing process for a product, which includes the steps of: providing a test set of inputs for a process of modifying a material; providing a process description including one or more governing equations; obtaining a characterization of a flow of the material using the process description and the test set of process inputs; obtaining a morphological characterization of the material using the flow characterization; predicting a value of the property of the material using the morphological characterization; using the value of the property to evaluate a measure of product performance; and determining whether the measure of product performance satisfies a predetermined criterion. If the criterion is not satisfied, one or more process inputs may be varied and the resulting property value predicted. This may be repeated in an iterative fashion until each of a set of one or more criteria are satisfied. Alternatively, the best set of process inputs may be determined based on how closely the predicted property values approximate a set of one or more target property values.

In another aspect, the invention includes an apparatus for predicting a value of a property of processed material, the apparatus including: a memory that stores code defining a set of instructions; and a processor that executes the instructions thereby to: obtain a characterization of flow of a material using a process description that includes one or more governing equations; obtain a morphological characterization of the material using the flow characterization; and predict a value of a property of the material using the morphological characterization.

In another aspect, the invention includes a method for predicting a property of processed material, the method including the steps of: providing a process description that includes one or more governing equations; obtaining a characterization of a flow of a material using the process model; providing a two-phase description of the material, where the description is based in part on the characterization of the flow of the material; obtaining a morphological characterization of the material using the two-phase description; and predicting a value of a property of the material using the morphological characterization. In one embodiment, the material undergoes a change of phase during processing. In one embodiment, the two-phase description includes an amorphous phase model and a semi-crystalline phase model.

In another aspect, the invention includes a method for simulating fluid flow within a mold cavity, the method including the steps of: providing a representation of a mold cavity into which a material flows; defining a solution domain based on the representation; and solving for a process variable in the solution domain at a time t using one or more governing equations, wherein the solving step comprises the substep of using a morphological characterization of the material in solving the governing equation(s). In one embodiment, the substep of using a morphological characterization of the material in solving the governing equation(s) comprises determining a viscosity of the material based on the morphological characterization, for example, at a time prior to time t.

In another aspect, the invention includes a method for predicting a morphological characteristic of structures within an injection-molded part, the method including the steps of: providing a model of an injection molding process; obtaining a characterization of flow of a material, where the flow occurs during the injection molding process; and predicting a morphological characterization of structures within at least a portion of the injection-molded part using the flow characterization. In one embodiment, the step of predicting a morphological characterization includes predicting one or more of: an orientation of crystallites within the injection-molded part; the size distribution of crystallites within the injection-molded part; the crystal volume as a function of position within the injection-molded part; and an orientation factor as a function of position within the injection-molded part. In one embodiment, the step of predicting a morphological characterization is performed using a description of crystallization kinetics of the material. In one embodiment, the description of crystallization kinetics includes an expression for excess free energy.

### BRIEF DESCRIPTION OF THE DRAWINGS

The objects and features of the invention can be better understood with reference to the drawings described below, and the claims. The drawings are not necessarily to scale, emphasis instead generally being placed upon illustrating the principles of the invention. In the drawings, like numerals are used to indicate like parts throughout the various views. The patent or application file contains at least one drawing executed in color. Copies of this patent or patent application publication with color drawing(s) will be provided by the U.S. Patent and Trademark Office upon request and payment of the necessary fee.

FIG. 1 is a block diagram featuring steps of a method for predicting properties of processed material, where the method accounts for the changing morphology of the material during processing, according to an illustrative embodiment of the invention.

FIG. 2 is a block diagram featuring steps of a method for performing structural analysis of a manufactured part, where the method accounts for the effect of process flow kinematics upon the morphology of the material, according to an illustrative embodiment of the invention.

FIG. 3 is a block diagram featuring steps of a method for performing structural analysis of a manufactured part—for example, an analysis of the warpage and/or shrinkage of an injection-molded part during a post-molding (i.e. cooling) process—where the method traces changing morphology and changing properties during the process to provide input for the structural analysis, according to an illustrative embodiment of the invention.

FIGS. 4A, 4B, and 4C show a block diagram featuring steps of a method for performing structural analysis of an injection-molded part, where the method accounts for the effect of flow kinematics during filling, packing, and post-molding stages upon the morphology of the material, according to an illustrative embodiment of the invention.

FIG. 5A depicts a representation of an injection-molded part for which a morphological characterization is determined, according to an illustrative embodiment of the invention.

FIG. 5B depicts a meshed solution domain for obtaining a characterization of the flow that occurs during the injection molding process of the part shown in FIG. 5A; following which, a morphological characterization is predicted as a function of skin-core depth measured from points A, B, and C, according to an illustrative embodiment of the invention.

FIG. 5C is a graph showing predicted crystal volume as a function of skin-core depth at points A, B, and C on the surface of the part shown in FIG. 5A following injection molding; the prediction accounts for process flow kinematics, according to an illustrative embodiment of the invention.

FIG. 5D is a graph showing a predicted crystalline orientation factor, f_{c}, as a function of skin-core depth at points A, B, and C on the surface of the part shown in FIG. 5A following injection molding; the prediction accounts for process flow kinematics, according to an illustrative embodiment of the invention.

FIG. 6A is a graph showing measured values of elastic modulus in directions normal and parallel to the flow direction, plotted as functions of depth in a 3-mm-thick injection molded part, according to an illustrative embodiment of the invention.

FIG. 6B is a graph showing predicted elastic modulus in directions normal and parallel to the flow direction, plotted as functions of depth in the 3-mm-thick injection-molded part of FIG. 6A; the prediction accounts for process flow kinematics, according to an illustrative embodiment of the invention.

FIG. 7A is a graph showing measured values of elastic modulus in directions normal and parallel to the flow direction, plotted as functions of depth in a 1-mm-thick injection molded part, according to an illustrative embodiment of the invention.

FIG. 7B is a graph showing predicted elastic modulus in directions normal and parallel to the flow direction, plotted as functions of depth in the 1-mm-thick injection-molded part of FIG. 7A; the prediction accounts for process flow kinematics, according to an illustrative embodiment of the invention.

FIG. 8 depicts output of a method for performing a warpage analysis of an injection-molded part, where the output is represented as a deflection map corresponding to the warpage prediction at a given time during a post-molding cooling process; the method accounts for the changing morphology and changing material properties during the process, according to an illustrative embodiment of the invention.

FIG. 9 is a graph showing measured values of shrinkage as functions of time in directions normal and parallel to the flow direction, according to an illustrative embodiment of the invention.

FIG. 10 depicts a computer hardware apparatus suitable for use in carrying out the methods described herein, according to an illustrative embodiment of the invention.

### DETAILED DESCRIPTION

Table 1 lists various symbols used herein and is provided as a convenience for the reader. Entries in Table 1 do not serve to limit interpretation of embodiments of the invention described herein.

TABLE 1
Notation

Description

Symbol

| | |
|---|---|
| α | Relative crystallinity (i.e. Equations 4, 19, 20, 24, 28) |
| α_{f} | Fictive volume fraction (i.e. Equations 21, 22, 24) |
| β, β₁ | Model parameters (i.e. Equations 4, 19) |
| χ_{∞} | Ultimate degree of crystallinity (i.e. Equation 31) |
| ε | Strain tensor (i.e. Equation 44) |
| ${ϵ}_{ij}^{0}$ | Uniform strain (i.e. Equations 39, 40) |
| ${ϵ}_{ij}^{T}$ | Transformation strain (i.e. Equations 39, 40) |
| εᵢⱼₖ | Permutation tensor (i.e. Equation 41) |
| \dot{γ} | Generalized shear rate (i.e. Equations 2, 3) |
| η | Viscosity (i.e. Equation 4) |
| ηₐ | Viscosity of amorphous phase (i.e. Equations 4, 20) |
| η* | = η′ − iη″, (complex viscosity (i.e. Equation 38) |
| λₐ | Relaxation time of amorphous phase (i.e. Equations 12, 15) |
| λ_{c} | Relaxation time of rigid dumbbell model (i.e. Equations 18, |
| | 19, 20) |
| λ_{N} | Nucleation relaxation time (i.e. Equation 29) |
| μ | Coefficient in the stress law (i.e. Equation 20) |
| ρ | Density (i.e. Equations 1, 2, 3) |
| σ | Total stress tensor (i.e. Equation 44) |
| τ | Extra stress (i.e. Equation 6) |
| τₐ | Amorphous contributed extra stress (i.e. Equations 6, 14) |
| τ_{c} | Semi-crystalline contributed extra stress (i.e. Equations 6, 20) |
| \hat{τ} | Two shear stress components of extra stress τ, |
| | where \hat{τ} = [τ₁₃, τ₂₃]. (i.e. Equation 33) |
| ω | Frequency (i.e. Equations 34, 35, 36, 37) |
| υₐ | Specific volume of amorphous phase |
| υ_{c} | Specific volume of crystalline phase |
| υₛ | Specific volume of final solid |
| ξ | Non-affine parameter (i.e. Equations 17, 18) |
| ψ | Configurational distribution function of dumbbell end-to-end |
| | vector under flow conditions (i.e. Equations 8, 9) |
| ψ₀ | Configurational distribution function of dumbbell end-to-end |
| | vector under equilibrium condition (i.e. Equation 8) |
| ζ | Friction coefficient (i.e. Equation 17) |
| a_{N} | Model parameter (i.e. Equation 28) |
| aₚ₀ | Model parameter (i.e. Equation 26) |
| aₚ₁ | Model parameter (i.e. Equation 26) |
| aₚ₂ | Model parameter (i.e. Equation 26) |
| a_{T} | Time-temperature shift factor (i.e. Equations 15, 16) |
| b | Dimensionless parameter in the FENE-P model (i.e. |
| | Equations 10, 12, 14) |
| b_{N} | Model parameter (i.e. Equation 28) |
| cₚ | Specific heat (i.e. Equation 3) |
| c | Dimensionless conformation tensor (i.e. Equations 10, |
| | 11, 12, 14) |
| c₀ | Dimensionless conformation tensor at equilibrium |
| | state (i.e. Equation 10) |
| f | Function of free energy change and temperature |
| | (i.e. Equations 29, 30) |
| f_{c} | Orientation factor (i.e. Equation 42) |
| g | Force per unit mass due to gravity (i.e. Equation 2) |
| k_{B} | Boltzmann constant 1.380658 × 10⁻²³ J/K |
| | (i.e. Equations 10, 14) |
| k, k | Thermal conductivity (i.e. Equations 3, 44) |
| m | Modified Avrami index (i.e. Equations 21, 22, 23) |
| Δn | Birefringence (i.e. Equation 43) |
| nₐ | Birefringence of amorphous phase (i.e. Equation 43) |
| n_{c} | Birefringence of perfectly aligned crystalline |
| | phase (i.e. Equation 43) |
| n₀ | Number density of molecules (i.e. Equations 10, 14) |
| q | Heat flux (i.e. Equation 44) |
| t | Time |
| u | Orientation vector (i.e. Equations 17, 18, 20) |
| v | Velocity |
| A | Model parameter (i.e. Equations 4, 19, 20) |
| C | Elastic moduli tensor (i.e. Equation 44) |
| Cᵢⱼₖₗ | Component of Elastic moduli tensor (i.e. |
| | Equations 39, 40) |
| ${C}_{ijkl}^{( a )}$ | Component of Elastic moduli tensor of the amorphous phase (matrix) (i.e. Equations 39, 49) |
| ${C}_{ijkl}^{( c )}$ | Component of Elastic moduli tensor of the semi- crystalline phase (inclusion) (i.e. Equations 39, 40) |
| C₀ | Model parameter (i.e. Equation 30) |
| Cₘ | Shape factor (i.e. Equation 22) |
| D | Rate of deformation tensor (i.e. Equation 20) |
| Eₐ | Activation energy for flow (i.e. Equation 16) |
| ΔF_{f} | Free energy change under flow conditions(i.e. |
| | Equations 10, 14, 30) |
| ΔF_{q} | Free energy change under quiescent conditions |
| | (i.e. Equation 30) |
| G | Crystalline growth rate |
| G₀ | Crystallization kinetics constant (i.e. Equation 25) |
| G′ | Storage modulus (i.e. Equations 36, 38) |
| G″ | Loss Modulus (i.e. Equations 37, 38) |
| G* | = G′ + iG″, complex modulus (i.e. Equation 38) |
| H | Hookean spring constant (i.e. Equation 11) |
| ΔH₀ | Latent heat (i.e. Equation 30) |
| I | Unit tensor (i.e. Equations 12, 14, 17, 20) |
| K_{g} | Crystallization kinetics constant (i.e. Equation 25) |
| L | Velocity gradient |
| Lₑ | Effective velocity gradient (i.e. Equations 17, 18) |
| N | Number of activated nuclei per unit volume (i.e. Equation 27) |
| N₀ | Number of activated nuclei per unit volume in |
| | quiescent condition (i.e. Equations 27, 28) |
| N_{f} | Number of activated nuclei per unit volume |
| | induced by flow (i.e. Equations 27, 29) |
| P | Pressure(i.e. Equation 26) |
| Q | End-to-end vector (i.e. Equations 8, 9, 11) |
| Q₀ | Maximum extension of spring |
| \dot{Q} | Heat flux (i.e. Equation 3) |
| R | Length of rigid link (i.e. Equation 17) |
| R_{g} | Molar gas constant 8.314510 J · mol⁻¹ · K⁻¹ |
| | (i.e. Equations 16, 25, 30) |
| S | Flow conductance (i.e. Equation 33) |
| T | Temperature |
| T₀ | Reference Temperature (i.e. Equation 16) |
| T_{g} | Glass transition temperature (i.e. Equation 25) |
| ${T}_{M}^{0}$ | Equilibrium melting temperature (i.e. Equations 25, 30) |
| T_{∞} | T_{∞} = T_{g} − 30 (i.e. Equations 25, 30) |
| ΔT | $Degree of supercooling ΔT = {T}_{m}^{0} - T ( i . e . Equations 25 , 30 )$ |
| U* | Activation energy (i.e. Equations 25, 30) |
| Operators | |
| < > | Ensemble average over orientation space |
| ( )^{T} | Transpose of matrix |
| $\frac{Δ}{Δt}$ | $\begin{matrix}\text{Upper-convected derivative, i.e. defined for c as:} \\ \frac{Δc}{Δt} = \frac{\partial c}{\partial t} + v \cdot ∇ c = ∇ {v}^{T} \cdot c - c \cdot ∇ v\end{matrix}$ |

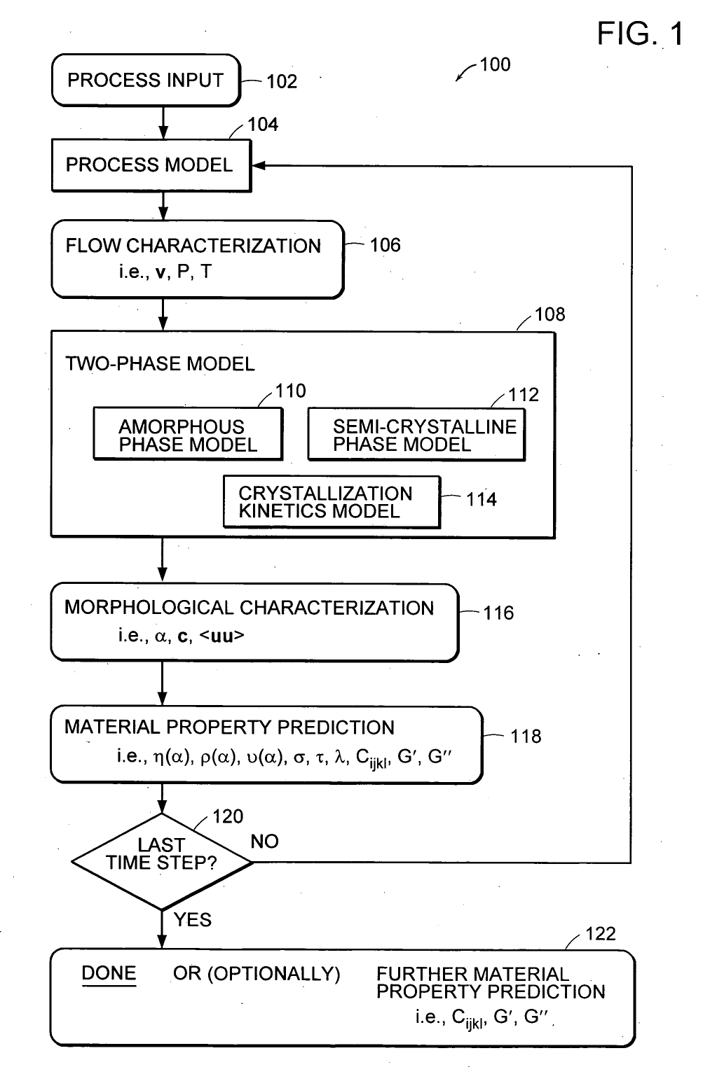

The invention provides methods of predicting material properties for use in the structural analysis of a manufactured part. The methods take into account the effect of processing on the morphology of the material of which the part is composed, particularly for parts composed of material that crystallizes or otherwise experiences a phase change or change of state during (and/or following) processing. FIG. 1 is a block diagram 100 featuring steps in an exemplary method of predicting properties of processed material. The method operates by solving a process model 104 to obtain a flow characterization 106 of the processed material at each of a series of time steps throughout a given process, and by using the flow characterization 106 at each time step in a two-phase crystallization model 108 to obtain a morphological characterization 116 of the material. One or more material properties are then predicted in step 118 as functions of the material morphology at the given time step. The predicted properties 118, in turn, are used in the process model 104 to predict the flow characterization 106 at the next time step, and the method repeats steps 104, 106, 108, 116, and 118 until the last time step 120. Although the time stepping in the block diagram 100 of FIG. 1 is explicit and non-recursive, an alternative embodiment includes an implicit and/or recursive solution procedure wherein the predicted material properties corresponding to a given time step are determined simultaneously with the flow characterization corresponding to the same time step.

The method of FIG. 1 ends after the final time step, or, optionally, the method proceeds by predicting additional material properties in step 122. It may not be necessary to trace the evolution of all material properties of interest throughout a given process. For example, some properties need only be predicted at the end of a given process. In certain embodiments, it is important to determine certain material properties—such as viscosity, density (or specific volume), and/or relaxation time—at each time step of a given process so that they may be used in obtaining the flow characterization 106 at the next time step. Then, after the final time step, additional material properties are predicted—for example, elastic modulus and complex modulus—based on the morphological characterization of the material at the end of the process. Alternatively, the predicted elastic modulus, complex modulus, and/or other more complex “derived” properties may be tracked throughout a given process as a function of process time.

The method of FIG. 1 includes a process model 104 that uses process input 102 to determine a flow characterization 106 throughout a given control volume at each of a series of time steps corresponding to a given manufacturing process. The process model 104 includes, for example, a solution domain representing a volume, such as the interior of a fluid injection mold, and the process model 104 solves a set of governing equations over the solution domain subject to given process input 102 in the form of initial conditions, boundary conditions, and model parameters. The process model 104 simulates one or more stages of a process, for example, an injection molding process, an extrusion process, a blow molding process, a vacuum forming process, a spinning process, or a curing process.

The governing equations for the process model 104 in the method of FIG. 1 includes, for example, mass (continuity), momentum, and energy conservation equations. Equations 1, 2, and 3 show generalized mass (continuity), momentum, and energy conservation equations, respectively:

$$\begin{matrix}\frac{\partial ρ}{\partial t} + v \cdot ∇ ρ + ρ ∇ \cdot v = 0 & ( 1 ) \\ ρ \frac{\partial v}{\partial t} = ρ g - ∇ P + [ ∇ \cdot η \dot{γ} ] - ρ [ v \cdot ∇ v ] & ( 2 ) \\ ρ {c}_{p} ( \frac{\partial T}{\partial t} + v \cdot ∇ T ) = - \frac{T}{ρ} \frac{\partial ρ}{\partial T} ( \frac{\partial P}{\partial t} + v \cdot ∇ P ) + & ( 3 ) \\ η {\dot{γ}}^{2} + ∇ \cdot ( k ∇ T ) + \dot{Q} & \end{matrix}$$

where v is velocity, ρ is density, P is pressure, η is viscosity, T is temperature, cₚ is heat capacity, and k is thermal conductivity. The energy conservation equation (Equation 3) accounts for the variation of temperature, as a function of position and time, due to convection, compressive heating, viscous dissipation, heat conduction, and/or heat sources such as heats of reaction. Equations 1, 2, and 3 may be simplified (or further generalized) according to the specific process and/or solution domain involved. The process model 104 of FIG. 1 can be solved for a control volume of arbitrary geometry using a computer-based numerical method. Various techniques for computer-based process simulation are presented in the following co-owned patent and co-owned patent applications, the disclosures of which are incorporated herein by reference in their entirety: U.S. Pat. No. 6,096,088, issued to Yu et al.; U.S. patent application Ser. No. 09/404,932, by Friedl et al.; and U.S. patent application Ser. No. 10/771,739, by Yu et al. Advances described in the above co-owned patent applications provide increased process modeling efficiency, which contributes to the overall speed and accuracy of the methods disclosed herein. Certain process simulation techniques are also presented in Flow Analysis of Injection Molds, by co-inventor Peter Kennedy, Hanser/Gardner Publications, Inc., Cincinnati (Hanser Publishers, New York), 1995.

In the method of FIG. 1, material undergoing processing is represented in the two-phase model 108 as a crystallizing system wherein a suspension of semi-crystalline entities grows and spreads in a matrix of an amorphous phase. The two-phase model 108 includes an amorphous phase constitutive model 110, a semi-crystalline phase constitutive model 112, and a crystallization kinetics model 114, where the crystallization kinetics model 114 describes how the semi-crystalline entities grow and spread in the amorphous phase matrix. The two-phase model 108 provides a morphological characterization 116 at a given time step. The morphological characterization 116 includes, for example, a relative crystallinity, a, an amorphous phase conformation tensor c, and/or a second-order orientation tensor <uu> for the semi-crystalline phase. Physical properties are then predicted in step 118 for the overall mixture as functions of the morphological characterization obtained in step 116. In this approach, the physical properties of the amorphous phase are assumed independent of the crystallinity, and the contribution of the semi-crystalline phase to the physical properties of the overall mixture is assumed to increase with increasing crystallinity. The viscosity of the whole system is represented by Equation 4 as follows:

$$\begin{matrix}\frac{η}{{η}_{a}} = 1 + \frac{{( α / A )}^{{β}_{1}}}{{( 1 - α / A )}^{β}} , & & & α < A ,\end{matrix} \qquad ( 4 )$$

where η is the viscosity of the overall mixture; ηₐ is the viscosity of the amorphous phase (which does not change with crystallinity); α is the relative crystallinity at a given time, where α is defined as the ratio of crystallized volume to the total crystallizable volume, or, equivalently, as the volume of the semi-crystalline phase, divided by the total volume; and A, β, and β₁ are empirical parameters.

The relative crystallinity, α, differs from the absolute crystallinity, where absolute crystallinity is defined as the ratio of the crystalline volume at a given time to the total volume. The relative crystallinity ranges from 0 to 1, whereas the absolute crystallinity never reaches 1, because the semi-crystalline phase does not consist of purely crystalline structures. In a preferred embodiment, microstructures are considered at the spherulite level, not at the lamellae level. That is, suspended “crystals” are modeled as complex aggregates of crystalline structures and amorphous phase material rather than as purely crystalline structures. Thus, in a preferred embodiment, the crystallized phase in the two-phase constitutive description of the material is referred to herein as the semi-crystalline phase. In Equation 4, A, β and β₁ are empirical parameters. Parameter A represents a geometrical effect and may range, for example, from about 0.44 to about 0.68. For smooth spherical crystallites, A is about 0.68; for rough compact crystallites, A is about 0.44. The value of A may be determined empirically. Parameters β and β₁ may also be empirically determined. Equation 4 may be used where α<A. When α→A, the calculated viscosity increases, approaching infinity.

The total stress of the two-phase system is expressed in Equation 5 as the sum of a thermomechanical stress (also called a “thermally and pressure-induced” stress) and a flow-induced “extra” stress (deviatoric stress) as follows:

σ=−pI+τ (5)

where σ is the total stress tensor, p is hydrostatic pressure (determined in the process model 104 of FIG. 1 as part of the flow characterization 106), I is the unit tensor, and τ is the extra stress tensor. In the crystallizing system, both the amorphous phase and the semi-crystalline phase contribute to internal stress, and the amorphous-contributed stress vanishes in the limit as α→1 (complete crystallization). The contribution of each of the two phases to the extra stress of the overall mixture is expressed, for example, according to the additive rule, as shown in Equation 6:

τ=τₐ+τ_{c}, (6)

where τₐ and τ_{c} are the extra stress contributions of the amorphous phase and the semi-crystalline phase, respectively. This characterization assumes an intimate mixture of two components at each point. This is a satisfactory approximation, particularly at the beginning of crystallization when crystallinity is low and crystals are small. In an embodiment involving the simulation of an injection molding process, Equation 6 may be used to calculate the flow-induced stresses associated with the material up to the point of substantially complete solidification of the material, at which point the stresses are characterized as “locked” in the frozen material. Thereafter, the material exhibits relaxation behavior resulting, at least in part, from the “locked” residual stresses. Since solidification usually occurs at low crystallinities, the application of Equation 6 in injection molding simulations is usually satisfactory. Alternatively, Equation 6 may be replaced by Equation 7 as follows:

τ=(1−α)τₐ+ατ_{c}. (7)

The flow-induced stress is generally about an order of magnitude less than the thermomechanical stress. However, flow-induced stress has a marked effect on the development of the microstructure of the material, and, therefore, flow-induced stress is considered in the method 100 of FIG. 1 for predicting material properties based on material morphology.

The extra stress in Equation 6 is determined using a micromechanical representation of each of the two phases of the material, generally in the form of a set of constitutive equations. The method of FIG. 1 features an amorphous phase model 110 and a semi-crystalline phase model 112, each in the form of one or more constitutive equations. Dumbbell models are used in a preferred embodiment of the invention, partly because of their computational simplicity. For example, the amorphous phase may be characterized using FENE-P dumbbells (i.e., a finite extensible non-linear elastic model with a Peterlin closure approximation), while the semi-crystalline phase is modeled as rigid dumbbells. Alternatively, other micromechanical models may be used. For example, the amorphous phase may be represented using a POM-POM model, an extended POM-POM model, a Giesekus model, or a Phan-Thien Tanner model.

The amorphous phase model 110 of FIG. 1 may be an elastic dumbbell model, in which a polymer chain is idealized as two beads linked by a finitely extendable connector tumbling along a path according to a given flow field determined, for example, in step 106 of FIG. 1. The flow-induced change of free energy for a system of elastic dumbbells is given by Equation 8 as follows:

$$Δ {F}_{f} = {n}_{0} {k}_{B} T \int ψ ( ln \frac{ψ}{{ψ}_{0}} ) ⅆ Q = {n}_{0} {k}_{B} T ⟨ ln \frac{ψ}{{ψ}_{0}} ⟩ , \qquad ( 8 )$$

where ΔF_{f} is the flow-induced free energy change per unit volume (measured in J/m³), n₀ is the number density of the molecules, k_{B} is the Boltzmann constant, T is the absolute temperature, and ψ is the configurational distribution function of the dumbbell end-to-end vector Q under flow conditions. The quantity ψdQ represents the probability of finding a dumbbell with the end-to-end vector lying between Q and Q+dQ, while ψ₀ is the corresponding equilibrium distribution function. The angular bracket denotes the ensemble average over the orientation space, weighted by the current distribution function ψ. The distribution function satisfies the equation of continuity in the configuration space, Equation 9 as follows:

$$\frac{\partial ψ}{\partial t} + \frac{\partial }{\partial Q} \cdot ( \dot{Q} ψ ) = 0 , \qquad ( 9 )$$

where the quantity \dot{Q} is determined by considering the force balance for the beads. For certain models of non-linear spring forces, Equation 9 is solved numerically. However, for the FENE-P model, Equation 9 can be solved analytically, and the corresponding free energy change is given as in Equation 10:

$$Δ {F}_{f} = \frac{1}{2} {n}_{0} {k}_{B} T \{ b ln [ \frac{1 - tr ( {c}_{0} ) / b}{1 - tr ( c ) / b} ] - ln [ \frac{det ( c )}{det ( {c}_{0} )} ] \} , \qquad ( 10 )$$

where b is a dimensionless parameter of the non-linear spring, defined as b=HQ₀²/k_{B}T, in which H is the spring elastic constant and Q₀ is the maximum extension of the dumbbell; tr(c) indicates the trace of the tensor c, i.e. the quantity c₁₁+c₂₂+c₃₃; det(c) indicates the determinant of the tensor c; c₀=[b/(b+3)]I where I denotes the unit tensor; and c is the dimensionless conformation tensor defined as in Equation 11:

$$c = \frac{H ⟨ QQ ⟩}{{k}_{B} T} , \qquad ( 11 )$$

The conformation tensor c satisfies the following constitutive equation, Equation 12:

$${λ}_{a} \frac{Δ c}{Δ t} + {( 1 - \frac{tr ( c )}{b} )}^{- 1} c = I , \qquad ( 12 )$$

in which λₐ=ζ/4H is the relaxation time of the fluid (amorphous phase), where ζ is a friction coefficient; and Δ/Δt is the upper-convected derivative defined as in Equation 13:

$$\frac{Δ c}{Δ t} = \frac{\partial c}{\partial t} + v \cdot ∇ c - ∇ {v}^{T} \cdot c - c \cdot ∇ v \qquad ( 13 )$$

where v is the velocity, ∇v is the velocity gradient, and the superscript T denotes transpose of a tensor. The velocity v is part of the flow characterization 106 determined from the process model 104 in the method of FIG. 1. The extra stress contributed by the amorphous phase may be described as in Equation 14:

$${τ}_{a} = 2 c \frac{\partial ( Δ {F}_{f} )}{\partial c} = {n}_{0} {k}_{B} T [ {( 1 - \frac{tr ( c )}{b} )}^{- 1} c - I ] . \qquad ( 14 )$$

In one embodiment, the solution of the above equations is characterized in terms of the relaxation time λₐ and the parameter b. Although these two parameters have a molecular interpretation, the model parameters ζ, H, and Q₀ are generally difficult to determine. The amorphous phase relaxation time, λₐ, may be determined from rheological data. The non-linear spring parameter b may also be determined from rheological data. However, b may alternately be considered an adjustable parameter. Calculations performed using values of b ranging from about 3 to about 1000 produce results that change in magnitude, but that demonstrate similar trends. In one embodiment, b is chosen to be about 5. By combining Equations 12, 13, and 14, the variable c can be eliminated and a constitutive equation is obtained in terms of the extra stress tensor τₐ.

In a preferred embodiment, the amorphous phase is characterized as a thermo-rheologically simple material; hence, the time-temperature superposition principle is used to account for the temperature dependence of λₐ as in Equation 15:

λₐ(T)=a_{T}(T)λₐ(T₀), (15)

where T₀ is a reference temperature, and a_{T} is a shift factor expressed in an Arrhenius form, as in Equation 16:

$$ln {a}_{T} ( T ) = \frac{{E}_{a}}{{R}_{g}} ( \frac{1}{T} - \frac{1}{{T}_{0}} ) , \qquad ( 16 )$$

where constant Eₐ/R_{g} is determinable from experimental data.

The semi-crystalline phase model 112 in the two-phase model 108 of FIG. 1 is a rigid dumbbell model, in which the polymer chain is characterized as two beads spaced a distance R and linked by a rigid connector tumbling along a path according to a given flow field. All the interactions with the solvent and the chain itself are localized at the two beads, each of which is associated with a frictional factor ζ and a negligible mass. The dumbbell itself does not represent the morphological details of the semi-crystalline phase, but it does have the feature of being oriented in the flow field, and its orientation distribution indicates the degree of anisotropy of the crystal growth. Since the rigid dumbbell is not stretchable, it is convenient to use a unit vector u to represent its orientation. The rate of change in the orientation of the unit vector may be expressed as in Equation 17:

$$\dot{u} = {L}_{e} \cdot u - {L}_{e} : uuu + \frac{1}{ζ R} ( I - uu ) \cdot {F}^{( b )} \qquad ( 17 )$$

where F^{(b)} is a random force, Lₑ is an effective velocity gradient defined as Lₑ=L−ξD; L=(∇V)^{T} is the velocity gradient; v is the velocity; ( )^{T} denotes the transpose operation; D is the rate of deformation tensor defined as D=(∇v+(∇V)^{T})/2; and ξ is the “non-affine” parameter ranging from about 0 to about 2. An increase of ξ reduces the relative strength of the strain rate with respect to the vorticity. The “non-affine” rigid dumbbell is similar to an ellipsoidal (or a rod-like) model that allows for a finite aspect ratio. In one embodiment, the method selects ξ=0.4, corresponding to a rod-like shape with an effective aspect ratio of 2.

Substitution of Equation 17 into the equation of continuity (i.e., Equation 9 with Q and \dot{Q} being replaced by u and \dot{u}, respectively) gives a Fokker-Planck equation that can be solved for the configurational distribution function ψ(u, t). A second-order orientation tensor is then calculable in terms of the distribution function as <uu>=∫uuψdu. Alternatively, an evolution equation is obtained for the second-order orientation tensor <uu> without using the Fokker-Planck equation, as in Equation 18:

$${λ}_{c} ( \frac{Δ ⟨ uu ⟩}{Δ t} + 2 {L}_{e} : ⟨ uuuu ⟩ ) + ⟨ uu ⟩ = \frac{1}{3} I , \qquad ( 18 )$$

where Δ/Δt is the upper-convected derivative (i.e. Equation 13) defined with the effective velocity gradient tensor Lₑ, and λ_{c} is the time constant of the rigid dumbbell, expressed as λ_{c}=ζR²/12 k_{B}T. Alternatively, λ_{c} is treated as an adjustable parameter that is a function of the relative crystallinity, as in Equation 19:

$$\begin{matrix}\frac{{λ}_{c}}{{λ}_{a}} = \frac{5 {( α / A )}^{{β}_{1}}}{2 {( 1 - α / A )}^{β}} , & & & α < A ,\end{matrix} \qquad ( 19 )$$

where λₐ is the relaxation time of the amorphous phase as characterized in Equations 12 and 15. Parameters A, β, and β₁ are characterized as in Equation 4 and are determined from experimental data. Equation 19 predicts that the relaxation time of the semi-crystalline phase is zero at zero crystallinity, and that the relaxation time increases, approaching infinity as α→A.

In order to calculate the second-order orientation tensor <uu> from Equation 18, one embodiment uses a closure approximation in order to express <uuuu> in terms of <uu>. In one embodiment, a closure approximation is used for three-dimensional orientation, which is exact for a random distribution and perfect alignment.

The contribution of the semi-crystalline phase to the extra stress may be characterized by Equation 20:

$${τ}_{c} = μ ( α ) ( 3 ⟨ uu ⟩ - I + 6 {λ}_{c} D : ⟨ uuuu ⟩ ) , \\ \begin{matrix}with μ ( α ) = \frac{{η}_{a} / {λ}_{a}}{1 - α / A} , & α < A\end{matrix} \qquad ( 20 )$$

The first term on the right hand side is the entropic term that has a relaxation time of the order λ_{c}, and the third term is the viscous stress term. Generally, in a rigid dumbbell system with a constant relaxation time, the viscous stress is considered to be instantaneous in the strain rate—the moment the flow stops, it disappears instantly. However, in a preferred embodiment, since the relaxation time λ_{c} increases dramatically as the melt is freezing, the viscous stress is considered to be “frozen” in the solidified material.

In addition to the amorphous phase model 110 and the semi-crystalline phase model 112 described herein above, the two-phase model 108 in the method of FIG. 1 includes a crystallization kinetics model 114 for determining the rate at which material changes from the amorphous phase to the semi-crystalline phase, accounting for the effect of flow as characterized by the process model 104. In one embodiment, the crystallization kinetics model 114 extends the Kolmogoroff/Avrami crystallization kinetics description of crystallization under quiescent conditions to account for the flow that takes place during material processing. The crystallization kinetics model 114 provides a link between flow-enhanced nucleation and change in free energy of the crystallizing, flowing material. In a preferred embodiment, crystal nucleation is described as a function of both flow and temperature, while crystal growth rate is described primarily (or exclusively) as a function of temperature. The crystallization kinetics of the material are described using an equation that relates a numerical index to the orientation of molecules of the polymer melt. The index may serve to indicate the orientation state of the crystalline material such that a value of about 3 indicates spherical crystallites, whereas values less than about 3 indicate an aligned orientation state of the crystallites.

For example, the crystallization kinetics model 114 in FIG. 1 characterizes a fictive volume fraction, α_{f}, of “phantom crystals” at time t (where overlapping of crystals is allowed) assuming (1) that a crystal begins growth with a linear growth rate G at time s, and (2) that the rate of nucleus creation per unit volume at time s is \dot{N}(s), according to Equation 21:

$${α}_{f} = {C}_{m} {\int }_{0}^{t} {\dot{N} ( s ) [ {\int }_{s}^{t} G ( u ) ⅆ u ]}^{m} ⅆ s , \qquad ( 21 )$$

or, as expressed in Equation 22 in differential form:

$$\frac{ⅅ {α}_{f}}{ⅅ t} = m {C}_{m} G ( t ) {\int }_{0}^{t} {\dot{N} ( s ) [ {\int }_{s}^{t} G ( u ) ⅆ u ]}^{m - 1} ⅆ s \qquad ( 22 )$$

where D/Dt denotes the substantial derivative, Cₘ is a shape factor and m is a dimensionality exponent, which may be considered a modified Avrami index. For example, for spherical growth, m=3 and Cₘ=4π/3; and for rod-like growth, m=1 and Cₘ represents the cross-section of the rod. In certain documents, the “Avrami index” refers to the exponent in the Avrami equation α=1−exp(−kt^{m′}) which is defined differently than index m in Equation 22.

In most processing situations there is a mixed dimensionality of crystal growth. Therefore, the crystallization kinetics model 114 of FIG. 1 allows the modified Avrami index, m, to take non-integer values, determined, for example, by data fitting. In a preferred embodiment, the modified Avrami index is expressed as a function of the orientation distribution of the semi-crystalline phase. For example, m is expressed as a function of the second invariant of the second order orientation tensor of the semi-crystalline phase according to Equation 23 as follows:

m=4−3<uu>:<uu>. (23)

In Equation 23, m equals 3 at a random orientation state, corresponding to spherical growth; and m equals 1 at the perfectly aligned orientation state, corresponding to rod-like growth. For non-integer values of m, the shape factor Cₘ may be treated as either an experimentally-determined constant or, alternatively, as a function of the orientation state. One embodiment uses the spherical shape factor, Cₘ=4π/3. In the case of injection molding, the spherical growth region occupies most areas and therefore this approximation is good.

The fictive volume fraction characterization of Equation 21 assumes that the volume of crystals grow unrestrictedly. Nevertheless, the two-phase model 108 relates fictive volume fraction to the actual relative crystallinity, for example, according to Equation 24:

α=1−exp(−α_{f}), (24)

where Equation 24 takes into account impingement due to the space filling effect.

In the case of short-term shear treatments, for example, the nucleation process is primarily affected by flow, and the growth rate is not strongly influenced by flow. Therefore, in one embodiment, the crystallization kinetics model 114 in the method of FIG. 1 assumes that the crystal growth rate depends only on temperature, as expressed in Equation 25:

$$G ( T ) = {G}_{0} exp [ - \frac{{U}^{*}}{{R}_{g} ( T - {T}_{∞} )} ] exp ( - \frac{{K}_{g}}{T Δ T} ) , \qquad ( 25 )$$

where G₀ and K_{g} are constants determined from experiments under quiescent conditions; U* is the activation energy of motion; R_{g} is the gas constant; T_{∞}=T_{g}−30 (where T_{g} is the glass transition temperature); and ΔT=Tₘ⁰−T is the degree of the supercooling with Tₘ⁰ being the equilibrium melting temperature, assumed to depend on pressure only. A polynomial function may be used to describe the pressure dependence as in Equation 26:

Tₘ⁰=aₚ₀+aₚ₁P+aₚ₂P², (26)

where aₚ₀, aₚ₁ and aₚ₂ are constants.

The crystallization kinetics model 114 of FIG. 1 describes the rate of nucleus generation per unit volume by expressing the total number of activated nuclei as the sum of the number of activated nuclei in the quiescent condition, N₀, and the number of activated nuclei induced by the flow, N_{f}, according to Equation 27:

N=N₀+N_{f}. (27)

The number of activated nuclei in the quiescent condition may be assumed to be a unique function of the supercooling temperature ΔT, described in Equation 28:

ln N₀=a_{N}ΔT+b_{N}, (28)

where a_{N} and b_{N} are constants.

The number of flow-induced nuclei is given by Equation 29 as follows:

$${\dot{N}}_{f} + \frac{1}{{λ}_{N}} {N}_{f} = f , \qquad ( 29 )$$

where λ_{N} is a relaxation time that has a large value and varies with temperature; and f is a function that takes into account the effect of flow. For example, f may be described by the expression ƒ=(\dot{γ}/\dot{γ}ₙ)² gₙ; where \dot{γ} is the shear rate, \dot{γ}ₙ is a critical shear rate of activation, and gₙ is an experimentally-determined or estimated factor [in m⁻³s⁻¹]. Alternatively, the term (\dot{γ}/\dot{γ}ₙ)² may be replaced with a function of the second invariant of the deviatoric volume invariant elastic Finger tensor. Since f represents the nucleation rate at t=0, one embodiment of the crystallization kinetics model 114 begins with an expression for the nucleation rate under quiescent conditions and adds the flow-induced free energy change to the expression, obtaining Equation 30:

$$\begin{matrix}f ( Δ {F}_{f} , T ) = {C}_{0} {k}_{B} T exp ( - \frac{{U}^{*}}{{R}_{g} ( T - {T}_{∞} )} ) \\ \{ ( Δ {F}_{q} + Δ {F}_{f} ) exp ( - \frac{{K}_{g}}{T [ ( 1 + ϑ Δ {F}_{f} ) {T}_{m}^{0} - T ]} ) - \\ Δ {F}_{q} exp [ - \frac{{K}_{g}}{T Δ T} ] \}\end{matrix} \qquad ( 30 )$$

where C₀ is an experimentally-determined constant; ΔF_{q} is the Gibbs free energy under quiescent conditions, expressed, for example, as ΔF_{q}=ΔH₀ΔT/Tₘ⁰ where ΔH₀ is the latent heat of crystallization; and factor [symbol] is given by [symbol] =Tₘ⁰/(ΔH₀T).

After the relative crystallinity (i.e., the volume fraction of the semi-crystalline phase) and the nucleation rate are calculated, the average volume of the spherulite may be described by V(t)=α(t)/N_{c}(t), where the active number of nuclei N_{c} is given by

N_{c}=∫₀\dot{N}(1−α)dt′.

Thus, the two-phase model 108 in the method of FIG. 1 provides a morphological characterization 116 of the crystallizing system as a function of the flow characterization 106 that is provided by the process model 104. The two-phase model 108 describes the crystallization rate by linking flow-enhanced nucleation to the free energy change of an amorphous phase subjected to the given flow field and by scaling crystal growth rate by a factor, m, where m is obtained from a micromechanical model of a semi-crystalline phase subjected to the given flow field. More specifically, the two-phase model 108 represents the amorphous phase of a two-phase crystallizing system with a micromechanical elastic dumbbell model; expresses the flow-induced free energy change of the amorphous phase, ΔF_{f}, as a function of conformation tensor, c, via Equation 10; and expresses c as a function of flow velocity v via the viscoelastic constitutive relationship of Equation 12. Equations 29 and 30 link the rate of flow-enhanced nucleation to the flow-induced free energy change, ΔF_{f}; and Equations 21, 24, and 27 link relative crystallinity, α, to the rate of flow-enhanced nucleation. Furthermore, the two-phase model 108 of FIG. 1 represents the semi-crystalline phase of the two-phase system using a rigid dumbbell model, where second-order orientation tensor <uu> is expressed as a function of flow velocity v via the viscoelastic constitutive relationship of Equation 18. Equation 23 links scaling factor m to the orientation tensor <uu> and Equations 21, 23, and 24 link relative crystallinity, α, to the orientation tensor <uu> under flow field v.

Certain embodiments of the invention include experimentally determining parameters related to crystallization kinetics and micromechanical constitutive relationships for use in the two-phase model 108 of the method of FIG. 1 to obtain a morphological characterization 116. For example, experiments relating to polypropylene crystallization are described in Koscher and Fulchiron, “Influence of Shear on Polypropylene Crystallization: Morphology Development and Kinetics,” Polymer 43 (2002), pp. 6931-6942.

Experiments may be conducted under quiescent (non-flow) conditions to determine various parameters for use in the two-phase model 108 of FIG. 1. For example, parameters Gₒ and K_{g} relating to crystal growth rate as modeled in Equation 25 may be obtained by performing experiments under quiescent conditions. Spherulite radii are obtained as a function of time for a given temperature using a polarized microscope. The resulting radii-versus-time plot is fitted with a linear function, and the growth rate for the given temperature obtained from the slope of the line. The experiment is repeated for different temperatures, and the data fitted according to Equation 25 to obtain parameters Gₒ and K_{g}.

Parameters a_{N} and b_{N} relating to the number of activated nuclei under quiescent conditions as modeled in Equation 28 may be obtained by (1) counting the number of nuclei from a microscopic image, (2) dividing by the area of the image, (3) converting to number of nuclei per unit volume N₀, where N₀=(number of nuclei/area)^{3/2}, and (4) curve-fitting according to Equation 28 to obtain parameters a_{N} and b_{N}.

Dynamic frequency sweep experiments may be performed to obtain relaxation spectrum λₐ and time-temperature shift factor a_{T} according to Equations 15 and 16.

Crystallization under shearing conditions (or after short term shearing) may be performed using a Linkam shearing hot stage device and a microscope. Transmitted intensity versus time may be measured and half crystallization times estimated therefrom. Crystallization experiments may also be performed with a rheometer. Measured rheometric properties during crystallization may be used to validate simulations and to compare results with those obtained via microscopy and/or via the Linkam shearing device.

The method shown in FIG. 1 includes obtaining a morphological characterization 116 of material at each of a plurality of time steps of the process simulation 104. For example, where the material undergoes an injection molding process, the method of FIG. 1 includes obtaining a morphological characterization of the material at a plurality of time steps of an initialization stage, a filling stage, a packing stage, and/or a post-molding stage (i.e. cooling stage) as described by the process model 104. The cooling stage may overlap part or all of the filling stage and/or the packing stage. The morphological characterization 116 is obtained using a description of crystallization kinetics of the material, as detailed herein above.

The following is an example of a solution procedure for obtaining a morphological characterization 116 at each of a series of time steps in the method shown in FIG. 1.

1. Perform a flow analysis to determine the flow kinematics for a process as a function of time. For example, determine distributions of pressure P, temperature T, and flow velocity v in a mold cavity at a given time step in an injection molding process simulation. For other processes, such as spinning, extrusion, vacuum forming or blow molding, describe the kinematics of the process based on governing equations, initial conditions, and boundary conditions as applied according to the specific process.

2. Using the flow kinematics calculated in step 1, calculate the conformation tensor c using Equation 12.

3. Calculate free energy ΔF_{f} using Equation 10.

4. Calculate function f using Equation 30.

5. Calculate nuclei number per unit volume N using Equations 27, 28, and 29.

6. Calculate growth rate G using Equations 25 and 26.

7. Calculate orientation tensor <uu> using Equation 18.

8. Calculate crystal growth factor m using Equation 23.

9. Calculate crystallinity a using Equations 22 and 24.

10. Calculate the amorphous stress τₐ using Equation 14.

11. Calculate the semi-crystalline phase stress τ_{c} using Equations 19 and 20.

12. Calculate the total stress τ using Equation 6.

13. Update viscosity η(α) using Equation 4.

14. Update relaxation times λₐ and λ_{c} using Equations 15, 16, and 19.

15. Update specific volume ν(α) (where ν(α)=ρ⁻¹(α)) using PVT (pressure-volume-temperature) relations to obtain the specific volume of pure crystalline (as opposed to semi-crystalline) phase and amorphous phase material, v_{ν} and νₐ, respectively. Example PVT relations are shown on pages 28-29 of Flow Analysis of Injection Molds, by Peter Kennedy, Hanser/Gardner Publications, Inc., Cincinnati (Hanser Publishers, New York), 1995. Then, solve Equations 31 and 32 for ν as follows:

νₛ=χ_{∞}ν_{c}+(1−χ_{∞})νₐ (31)

ν=ανₛ+(1−α)νₐ (32)

where χ_{∞} is the ultimate degree of crystallinity for the material (the maximum absolute crystallinity, generally determined experimentally), α is the relative crystallinity predicted in step 9, νₛ, and νₐ are respectively the specific volumes of the semi-crystalline and amorphous phases, and ν is the specific volume of the mixture of the semi-crystalline and amorphous phases. Alternatively, if it is assumed that the ultimate degree of crystallinity, χ_{∞}, is a constant that does not change with different processing conditions, then values of νₛ and νₐ may be obtained from PVT (pressure-volume-temperature) relations for the material and Equation 32 is solved for ν using a predicted in step 9.

16. Go back to the process model 104 to determine the flow kinematics at the next time step, using the updated viscosity η(α) and specific volume ν(α) determined in steps 13 and 15. Repeat steps 2 through 16 until the time step corresponding to the end of the process or process stage is reached.

The ordering of steps above may be adjusted. For example, in an alternate embodiment, step 10 is performed immediately after step 2; and/or steps 11 and 12 are performed immediately after step 7. Also, if the conformation tensor, c, is replaced by the stress tensor in Equations 10 and 12, via Equation 14, the calculation above will be expressed in terms of the stress instead of the conformation tensor, and the effect of stress on the properties is seen more directly. Stress is closely related to the conformation tensor and the orientation tensor as shown in Equations 14 and 20. Stress is a macroscopic quantity, while the conformation tensor and the orientation tensor are microstructural representations. In one embodiment, the volume of spherulites are calculated from the calculated crystallinity and nuclei number per unit volume, if necessary.

Under certain process conditions, the continuity and momentum conservation equations (Equations 1 and 2) of the process model 104 in FIG. 1 can be combined and expressed as the Hele-Shaw equation, Equation 33 as follows:

∇·(S∇p+\hat{τ})=B (33)

where B represents compressibility terms; S is flow conductance, evaluated as

$$S = {\int }_{0}^{h} \frac{{z}^{2}}{η ( z )} ⅆ z$$

where h is the half-thickness of a cavity within which the material flows, η is viscosity, and z is the coordinate in the thickness direction measured from the center line; and \hat{τ}=[τ₁₃, τ₂₃] are the two shear stress components of the extra stress τ (the quantity \hat{τ} is used instead of the full tensor τ because the other components of the stress tensor are neglected in the Hele-Shaw equation). The quantity \hat{τ} is related to the morphological characterization 116 of FIG. 1 (i.e. the conformation tensor c and the orientation tensor <uu>) via Equations 6, 14, 18, and 20, for example.

One embodiment of the method of FIG. 1 employs a “coupled” approach in which the Hele-Shaw equation (or other form of the momentum and continuity equations of the process model 104) is solved simultaneously with equations of the two-phase model 108, for example, Equations 6, 14, 18, and 20.

In order to reduce computer processing time and data storage requirements, one embodiment of the method of FIG. 1 employs a “decoupled” approach in which the Hele-Shaw equation (or other form of the momentum and continuity equations of the process model 104) is solved by neglecting the extra stress term \hat{τ} in Equation 33 to determine the flow characterization 106 in the method of FIG. 1. The flow characterization 106 is then used in the two-phase model 108 (i.e. amorphous phase and semi-crystalline phase constitutive equations, Equations 12 and 18) to determine the morphological characterization 116. Thus, the decoupled approach assumes generalized Newtonian behavior (neglecting extra stress) for purposes of solving the process model 104 to determine the flow characterization 106; however, the decoupled approach does account for extra stress in the two-phase model 108 for purposes of determining the morphological characterization in step 116 and for purposes of predicting material properties in step 118. Certain material properties that are determined in step 118 (for example, viscosity and density) are used, in turn, as inputs in the process model 104 for computing the flow characterization 106 at the next time step in the decoupled approach. For example, in a decoupled approach that employs the Hele-Shaw equation, viscosity η(α), determined in step 118 of FIG. 1 as a function of relative crystallinity α, is fed back into the process model 104 (i.e. Equation 33) via the fluidity coefficient (flow conductance), S, in order to determine the flow characterization 106 at the next time step.

In addition to viscosity η(α), density ρ(α), specific volume ν(α), total stress σ, extra stress τ, and relaxation time λ, step 118 of the method of FIG. 1 can include prediction of properties such as elastic modulus, complex modulus, and/or dynamic viscosity. For example, values of complex modulus G* (or, G′ and G″) at one or more selected locations within or on the surface of a manufactured part can be predicted by solving the constitutive equations in each phase of the two-phase model 108 in FIG. 1 for the case of small-amplitude oscillation shear flow of a polymer fluid between two parallel plates. A perturbation technique may be used to solve the micromechanical models discussed herein above for the xy components of extra stress in the semi-crystalline and amorphous phases, as shown in Equations 34 and 35, respectively:

$$\begin{matrix}{( {τ}_{c} )}_{xy} = μ \{ \frac{3 {λ}_{c}^{2} {ω}^{2}}{5 ( 1 + {λ}_{c}^{2} {ω}^{2} )} {γ}_{0} sin ω t + & ( 34 ) \\ [ \frac{3 {λ}_{c} ω}{5 ( 1 + {λ}_{c}^{2} {ω}^{2} )} + \frac{2}{5} {λ}_{c} ω ] {γ}_{0} cos ω t \} & \\ {( {τ}_{a} )}_{xy} = \frac{{n}_{0} {k}_{B} T {\hat{λ}}_{a} ω {γ}_{0}}{( 1 + {\hat{λ}}_{a}^{2} {ω}^{2} )} [ {\hat{λ}}_{a} ω sin ω t + cos ω t ] & ( 35 )\end{matrix}$$

where one of the plates oscillates with frequency ω in its own plane in the x-direction; y is the direction normal to both plates;

$${\hat{λ}}_{a} = \frac{b}{b + 3} {λ}_{a} ;$$

and γ₀ is the amplitude of the shear strain. It follows that G′ and G″ are determined according to Equations 36 and 37 as follows:

$$\begin{matrix}{G}^{′} = \frac{3 μ {λ}_{c}^{2} {ω}^{2}}{5 ( 1 + {λ}_{c}^{2} {ω}^{2} )} + \frac{{n}_{0} {k}_{B} T {\hat{λ}}_{a}^{2} {ω}^{2}}{1 + {\hat{λ}}_{a}^{2} {ω}^{2}} & ( 36 ) \\ {G}^{″} = \frac{3 μ {λ}_{c} ω}{5 ( 1 + {λ}_{c}^{2} {ω}^{2} )} + \frac{2}{5} μ {λ}_{c} ω + \frac{{n}_{0} {k}_{B} T {\hat{λ}}_{a} ω}{1 + {\hat{λ}}_{a}^{2} {ω}^{2}} & ( 37 )\end{matrix}$$

Since μ and λ_{c} are functions of α, it follows that the values of G′ and G″ are functions of α and ω. Dynamic viscosity is related to complex modulus according to Equation 38:

$${η}^{*} = {η}^{′} - ⅈ {η}^{″} = \frac{{G}^{*}}{ⅈ ω} = \frac{{G}^{″}}{ω} - ⅈ \frac{{G}^{′}}{ω} \qquad ( 38 )$$

The equivalent elastic moduli tensor of the processed polymer Cᵢⱼₖₗ may be determined from the following information: (1) the elastic moduli tensor of the amorphous phase (matrix), Cᵢⱼₖₗ^{(a)}; (2) the elastic moduli tensor of the semi-crystalline phase (inclusion), Cᵢⱼₖₗ^{(c)}; and (3) the morphological characterization determined in step 116 of FIG. 1, for example, relative crystallinity α, geometry [considering ellipsoidal inclusions with the three principal axes αᵢ (i=1, 2, 3)] and orientation. Items (1) and (2) are obtained using measurements of acoustic modulus. Item (3) is determined using methods described herein above. It follows that the equivalent elastic moduli tensor of processed polymer, Cᵢⱼₖₗ, may be described according to Equation 39 as follows:

$${C}_{ijkl} = {C}_{ijmn}^{( a )} {{ϵ}_{mn}^{0} ( {ϵ}_{kl}^{0} + α {ϵ}_{kl}^{T} )}^{- 1} . \qquad ( 39 )$$

where εᵢⱼ⁰ is the uniform strain in the polymer matrix without crystal inclusions, and εᵢⱼ^{T} is the transformation strain, or the eigenstrain, of an inclusion, wherein, if the inclusion were a separate body, it would acquire a uniform strain εᵢⱼ^{T} with no surface traction or stress. The quantity εᵢⱼ^{T} may be expressed in terms of εᵢⱼ⁰ according to Equation 40:

$$( {C}_{ijkl}^{( c )} - {C}_{ijkl}^{( a )} ) [ {ϵ}_{kl}^{0} + ( 1 - α ) {E}_{klmn} {ϵ}_{mn}^{T} + α {ϵ}_{kl}^{T} ] + {C}_{ijkl}^{( a )} {ϵ}_{kl}^{T} = 0 , \qquad ( 40 )$$

where Eᵢⱼₖₗ is Eshelby's transformation tensor, and its components depend on the geometry of the inclusion and the elastic constants of the matrix. This formulation allows consideration of systems with inclusions ranging from spherical, to oblate, to penny-like and cylindrical shapes, and, thus, anisotropic, effective properties can be predicted.

Values of components of the Eshelby tensor may be determined, for example, using a rectangular Cartesian coordinate system [xᵢ (i=1, 2, 3)] having an origin at the center of an ellipsoid and axes xᵢ aligned with the principal axes aᵢ, according to Equation 41 as follows:

$$\begin{matrix}{E}_{ijkl} = \frac{1}{8 π} {C}_{mnkl}^{( a )} {\int }_{- 1}^{1} ⅆ {x}_{3} {\int }_{0}^{2 π} [ {G}_{imjn} ( \overline{x} ) + {G}_{jmin} ( \overline{x} ) ] ⅆ θ , \\ where \\ {G}_{ijkl} ( \overline{x} ) = {\overline{x}}_{k} {\overline{x}}_{l} {N}_{ij} ( \overline{x} ) / Ω ( \overline{x} ) , \\ {\overline{x}}_{i} = {x}_{i} / {a}_{i} , \\ {x}_{1} = \sqrt{1 - {x}_{3}^{2}} cos θ , \\ {x}_{2} = \sqrt{1 - {x}_{3}^{2}} sin θ , \\ Ω ( \overline{x} ) = {ϵ}_{mnl} {K}_{m1} {K}_{n1} {K}_{l1} , \\ {N}_{ij} ( \overline{x} ) = \frac{1}{2} {ϵ}_{ikl} {ϵ}_{jmn} {K}_{k m} {K}_{l n} , \\ {K}_{ik} = {C}_{ijkl}^{( a )} {\overline{x}}_{j} {\overline{x}}_{l} ,\end{matrix} \qquad ( 41 )$$

and where εᵢⱼₖ is the permutation tensor defined as follows:

$${ϵ}_{ijk} = \{ \begin{matrix}1 , & if ijk = 123 , 231 , or 312 \\ - 1 , & if ijk = 321 , 132 , or 213 \\ 0 , & if any two indices are alike\end{matrix} .$$

The double integration may be computed numerically using Gaussian quadratures for general cases. For simpler cases, such as transversely isotropic materials, explicit expressions for the Eshelby tensor may be used.

Various properties of the processed material may be determined from values of complex modulus. For example, the Cox-Merz rule may be applied to predict steady state shear viscosity from values of G′ and G″. Values of volume thermal expansion coefficient, compressibility, bulk modulus, and sound speed may be determined from the predicted crystallinity-dependent PVT (pressure-volume-temperature) data.

Birefringence can be estimated from the molecular orientation obtained as part of the morphological characterization 116 in the method of FIG. 1. This is done by first computing an orientation factor of the semi-crystalline phase, f_{c}, from the calculated orientation tensor according to Equation 42:

$${f}_{c} = \frac{3 ⟨ {u}_{1} {u}_{1} ⟩ - 1}{2} , \qquad ( 42 )$$

where <uᵢuⱼ> is a component of tensor <uu> in Cartesian coordinates, and subscript 1 denotes the flow direction. The orientation factor is a measurement of the semi-crystalline orientation with respect to the flow direction. For example, f_{c}=0 corresponds to random orientation, f_{c}=1 for perfect alignment in the flow direction, and f_{c}=−0.5 for perpendicular orientation. Similarly, an orientation factor, fₐ, is obtained for the amorphous phase from the FENE-P model (Equation 12). Given the birefringence values of the perfectly oriented phases, n_{c} and nₐ, respectively, the birefringence Δn can be calculated according to Equation 43 as follows:

Δn=αχ_{∞}ƒ_{c}n_{c}+(1−αχ_{∞})fₐnₐ (43)

where αχ_{∞} is absolute crystallinity.

The analogy between heat transfer theory and mechanical theory is expressed by Equation 44, as follows:

q=k·∇T [symbol] σ=C·ε (44)

where q is the heat flux and k is the thermal conductivity. The methods described herein for predicting mechanical properties may likewise be used to predict thermal conductivity and other thermal properties, according to the analogy of Equation 44.

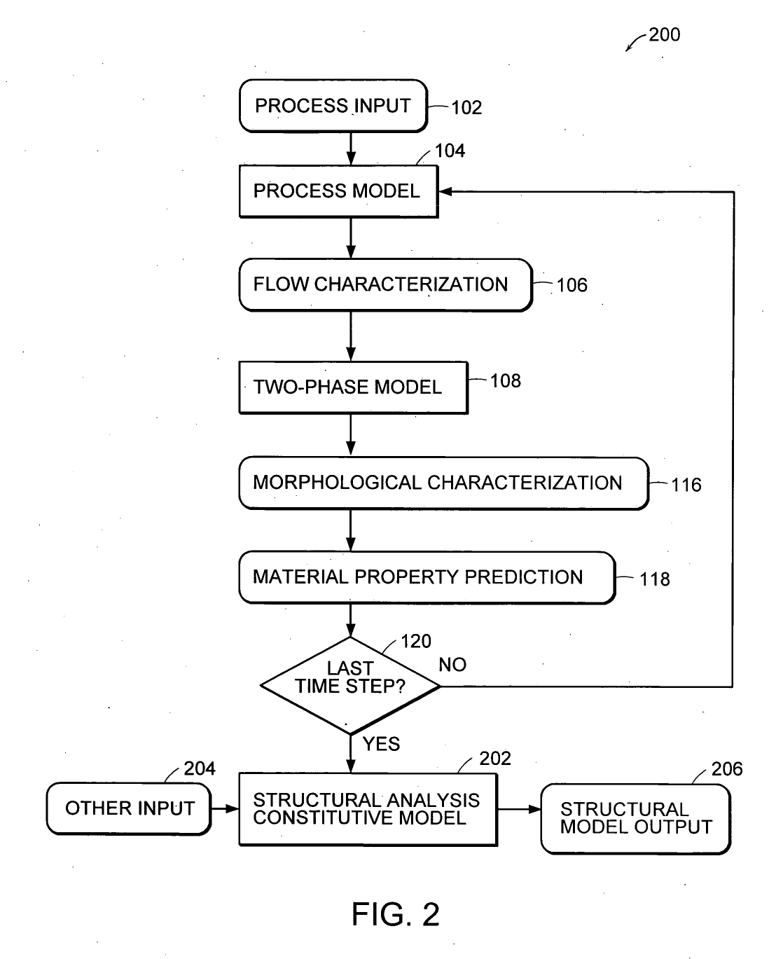

FIG. 2 is a block diagram 200 featuring steps of a method for performing structural analysis of a manufactured part using values of material properties predicted in a way that accounts for the flow of the material during manufacturing. The method includes elements of the method of FIG. 1, as discussed herein above, along with a structural analysis constitutive model 202 of the manufactured part.

As in the method of FIG. 1, the method of FIG. 2 includes solving a process model 104 to obtain a flow characterization 106 of the processed material at each of a series of time steps throughout a given manufacturing process (or one or more stages of a process), and using the flow characterization 106 at each time step in a two-phase crystallization model 108 to obtain a morphological characterization 116 of the material. One or more material properties are then predicted in step 118 as functions of the material morphology at the given time step. The predicted properties 118, in turn, are used in the process model 104 to predict the flow characterization 106 at the next time step, and the method repeats steps 104, 106, 108, 116, and 118 until the last time step 120. Items 102, 104, 106, 108, 116, 118, and 120 in FIG. 2 are discussed in more detail herein above with regard to the method of FIG. 1.

The method of FIG. 2 adds the step of using material properties predicted according to the method above in a structural analysis constitutive model 202 of the manufactured part. The structural analysis constitutive model 202 may be, for example, a dynamic mechanical analysis (DMA) model, a mechanical event simulation (MES), a warpage model, a crack propagation model, or a model to predict creep, wear, hysteresis, rolling resistance, impact strength, stiffness, failure, and/or aging phenomena of the manufactured part. In a preferred embodiment, the one or more material properties used as input in the structural analysis constitutive model 202 correspond to the state of the material of the manufactured part as it exists after completion of the process modeled in step 104. However, a trace of the evolution of the one or more properties throughout the modeled process may be used as input in the structural analysis model 202. In addition to the predicted material properties, other inputs 204 used in the structural analysis constitutive model 202 of FIG. 2 may include, for example, external forces, loads, supports, environmental conditions, and the like. The structural model output 206 includes, for example, the predicted response of the manufactured part to imposed forces, and/or values quantifying extent of crack propagation, creep, wear, hysteresis, rolling resistance, impact strength, stiffness, failure, and/or aging.

In certain embodiments, not all properties predicted in step 118 of the method of FIG. 2 are used in the structural analysis constitutive model 202. For example, certain properties predicted in step 118, such as viscosity η(α) and density ρ(α) (determined as functions of relative crystallinity α) are computed for purposes of accounting for changing material morphology in the process model 104, and are not necessarily used as input in the structural analysis constitutive model 202. Other properties that are predicted in step 118 of FIG. 2, such as elastic modulus and complex modulus, are used as inputs in the structural analysis constitutive model 202. Note that these predicted properties may be determined as functions of the morphological characterization corresponding to the end of the process modeled in step 104, and are not necessarily predicted at each time step of the process model 104. Furthermore, in certain embodiments, the process model 104 and the two-phase model 108 are not necessarily updated at each time step. For example, the material properties predicted in step 118 may not be updated at each time step corresponding to the process model 104 for purposes of obtaining the morphological characterization 116 and predicting the flow characterization 106. A morphological characterization 116 determined for a given time t may be considered to be adequate for purposes of determining the flow characterization at two or more time steps of the process model 104. Also, the discretization of the solution domain of the process model 104 may differ from that of the two-phase model 108 and/or the structural analysis constitutive model 202, since these models involve the solution of different sets of equations.

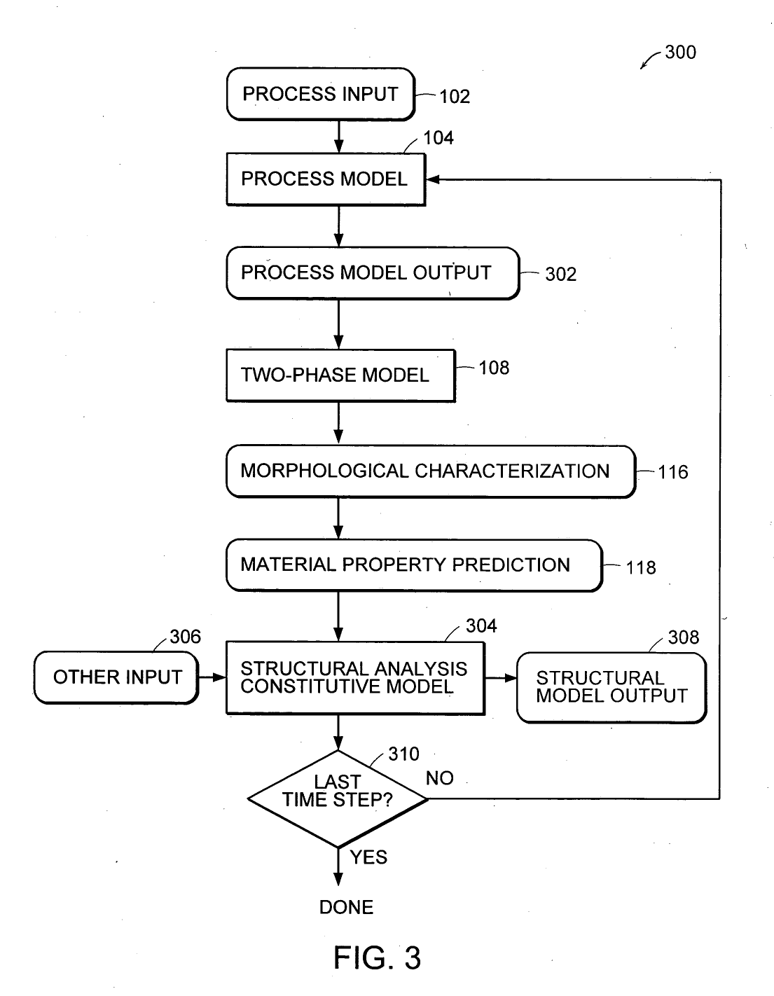

FIG. 3 is a block diagram 300 featuring steps of a method for performing structural analysis of a manufactured part—for example, an analysis of the warpage and/or shrinkage of an injection-molded part during a post-molding cooling and/or reheating process—where the method traces changing morphology and changing properties during the process to provide input for the structural analysis. As with the method of FIGS. 1 and 2, the method of FIG. 3 includes solving a process model 104. However, the method of FIG. 3 produces process model output 302 that may or may not relate to a flow characterization of the processed material, since there may be zero flow; for example, the process model 104 may simulate the cooling and/or the subsequent reheating of a manufactured part after de-molding. Even if there is no flow, the morphology of the material may be changing during the process, thus, a two-phase crystallization model 108 is used to obtain a morphological characterization 116 of the material at a given time step of the process. One or more material properties are then predicted in step 118 as functions of the material morphology at the given time step. The predicted properties 118, in turn, may be used in the process model 104 to predict the process model output 106 at the next time step, and the method repeats steps 104, 302, 108, 116, and 118 until the last time step. Alternatively, the process model 104 may be solved independently, without the feedback loop shown in FIG. 3, if the process model output 302 is not affected by the changing material properties predicted in step 118.

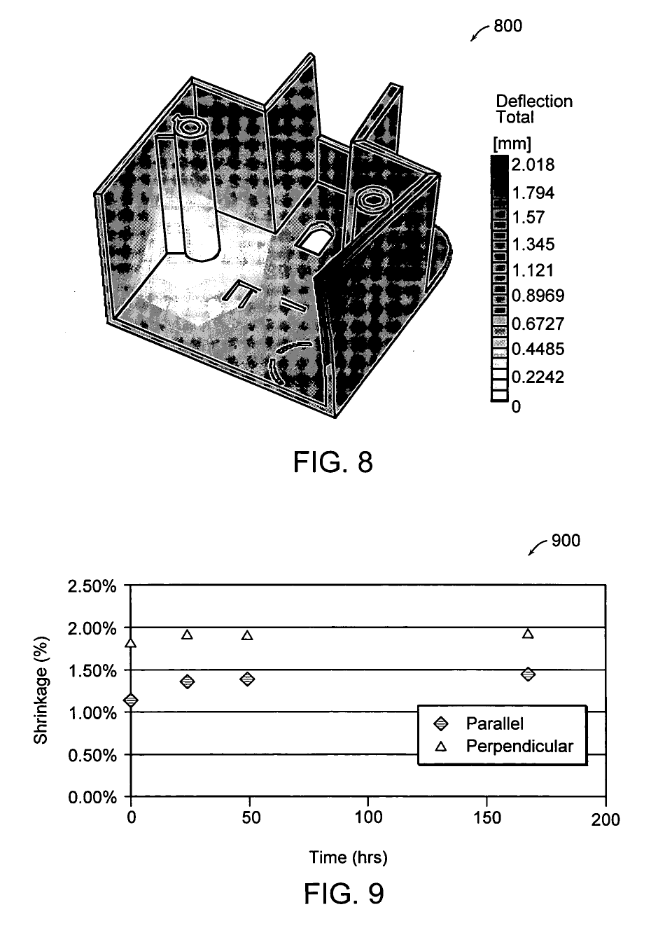

The method of FIG. 3 differs from the method of FIG. 2 in that the structural analysis constitutive model 304 uses material properties predicted in step 118 corresponding to the material at a plurality of time steps during the process being modeled. For example, where the process is a post-molding cooling or reheating stage of the injection molding of a part, the structural analysis constitutive model 304 may be a shrinkage or warpage model that uses the evolution of one or more material properties predicted in step 118 as input. An example of a warpage analysis is discussed in more detail with respect to FIG. 8 herein below.

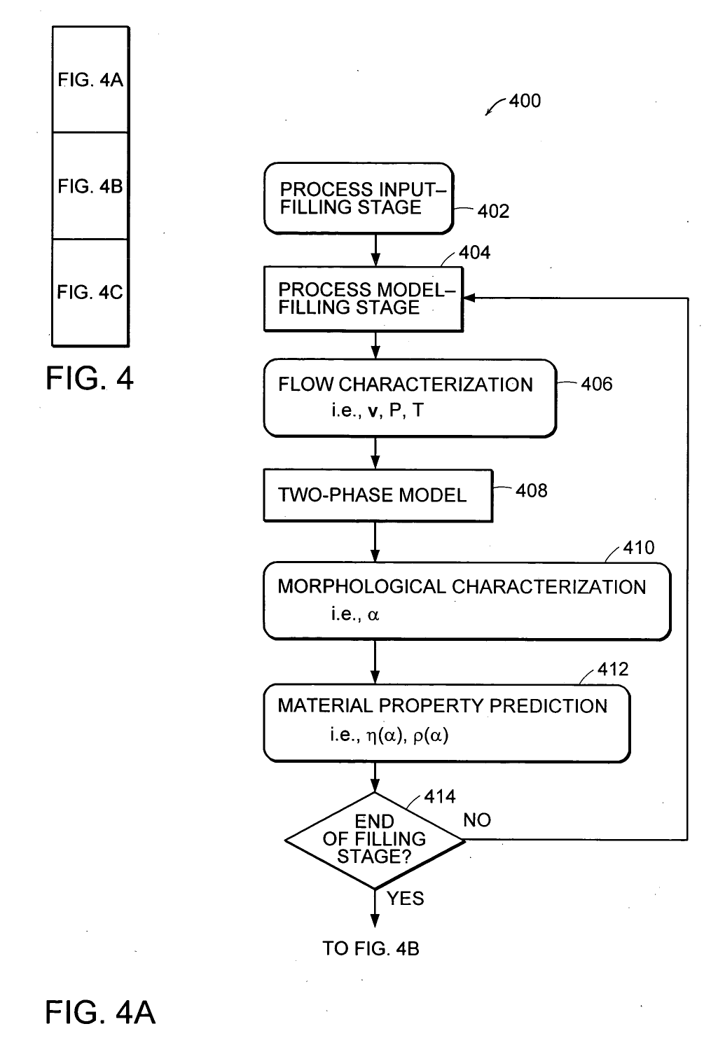

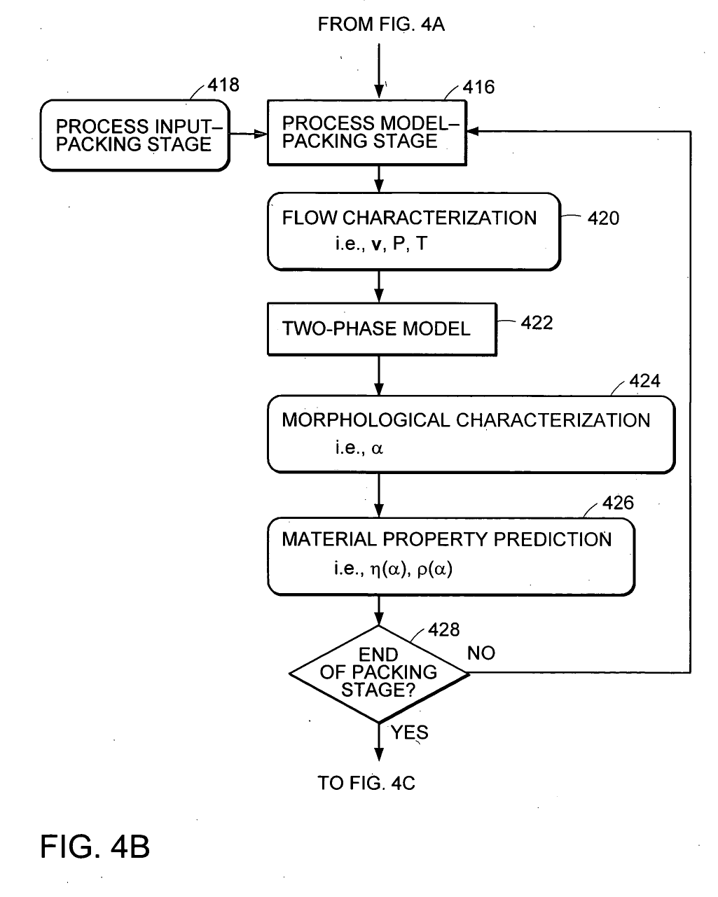

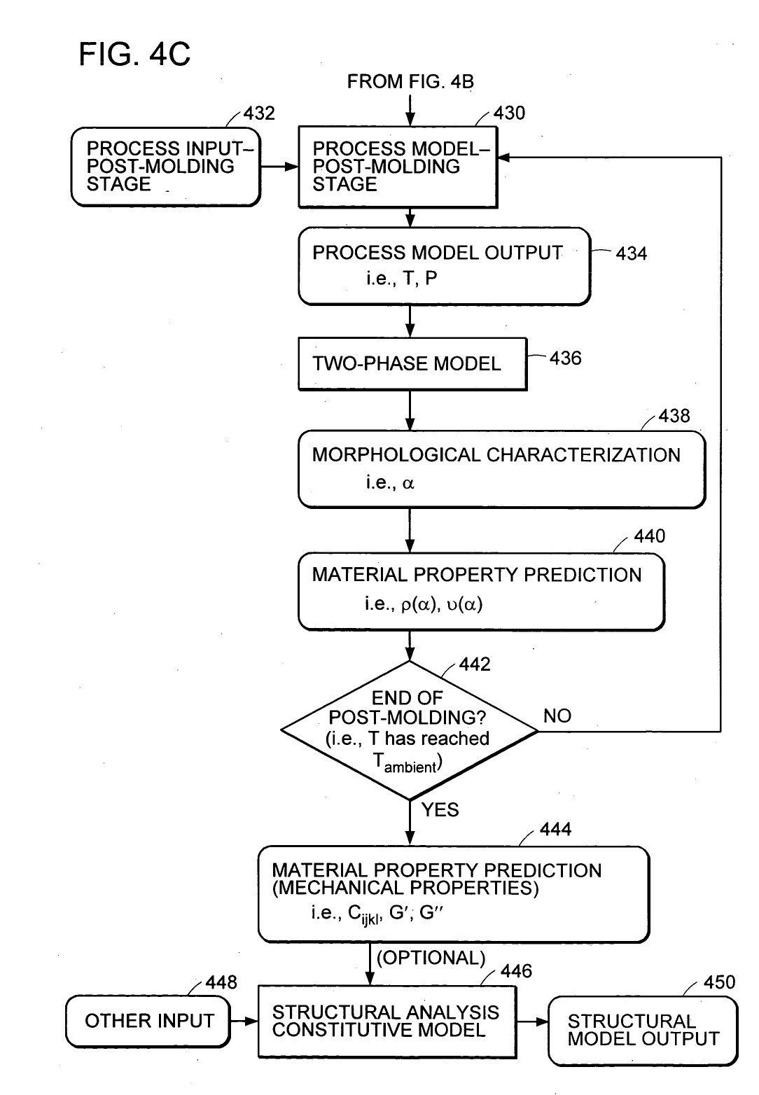

FIGS. 4A, 4B, and 4C show a block diagram 400 featuring steps of a method for performing structural analysis of an injection-molded part, where the method accounts for the effect of flow kinematics and process conditions during filling, packing, and post-molding stages upon the morphology of the material of the manufactured part. The method of FIGS. 4A, 4B, and 4C demonstrates the prediction of material properties throughout a multi-stage manufacturing process. The method of FIG. 4 includes solving a model 404 of the filling phase of an injection molding process using process input 402 to obtain a flow characterization 406 of the material at each of a series of time steps throughout the filling phase, and using the flow characterization 406 at each time step in a two-phase crystallization model 408 to obtain a morphological characterization 410 of the material. One or more material properties are then predicted in step 412 as functions of the material morphology at the given time step. The predicted properties 412, in turn, are used in the process model 404 to predict the flow characterization 406 at the next time step, and the method repeats steps 404, 406, 408, 410, and 412 until the last time step of the filling phase 414, after which the method proceeds to the packing phase model 416 of FIG. 4B. In certain embodiments, an initialization stage is modeled prior to the filling stage. Items 402, 404, 406, 408, 410, and 412 in FIG. 4A are discussed in more detail herein above with regard to analogous steps in the method of FIG. 1.

Items 416, 418, 420, 422, 424, 426, and 428 in FIG. 4B regarding the packing stage of the injection molding process are analogous to items in FIG. 4A. Likewise, items 430, 432, 434, 436, 438, 440, and 442 in FIG. 4C regarding the post-molding (i.e. cooling) stage of the injection molding process are analogous to items in FIGS. 4A and 4B. At the end of post-molding (for example, when the temperature of the material throughout the manufactured part has equilibrated to ambient temperature), mechanical properties are predicted in step 444—for example, elastic modulus and complex modulus—and are used as inputs in a structural analysis constitutive model 446, along with other input 448, to produce structural model output 450. The structural analysis constitutive model 446 may be, for example, a dynamic mechanical analysis (DMA) model, a mechanical event simulation (MES), a warpage and/or shrinkage model, a crack propagation model, or other model to predict creep, wear, hysteresis, rolling resistance, impact strength, stiffness, failure, and/or aging phenomena of the manufactured part. In a preferred embodiment, the material properties predicted in step 444 of FIG. 4C correspond to the state of the material of the manufactured part as it exists after completion of the injection molding process. However, a trace of the evolution of the one or more properties throughout the modeled process may be used as input 444 in the structural analysis model 446. After ejection from a mold, a part may undergo a cooling and/or reheating process. For example, in the automotive industry, paint is applied to a de-molded part and the part is cured by exposure to elevated temperature. As the temperature of the part increases, the material properties of the part change, and relaxation of stresses may cause warpage. The evolution of the material properties of the part during the post-molding process may be determined in step 444 of FIG. 4C and used as input in the structural analysis model 446.

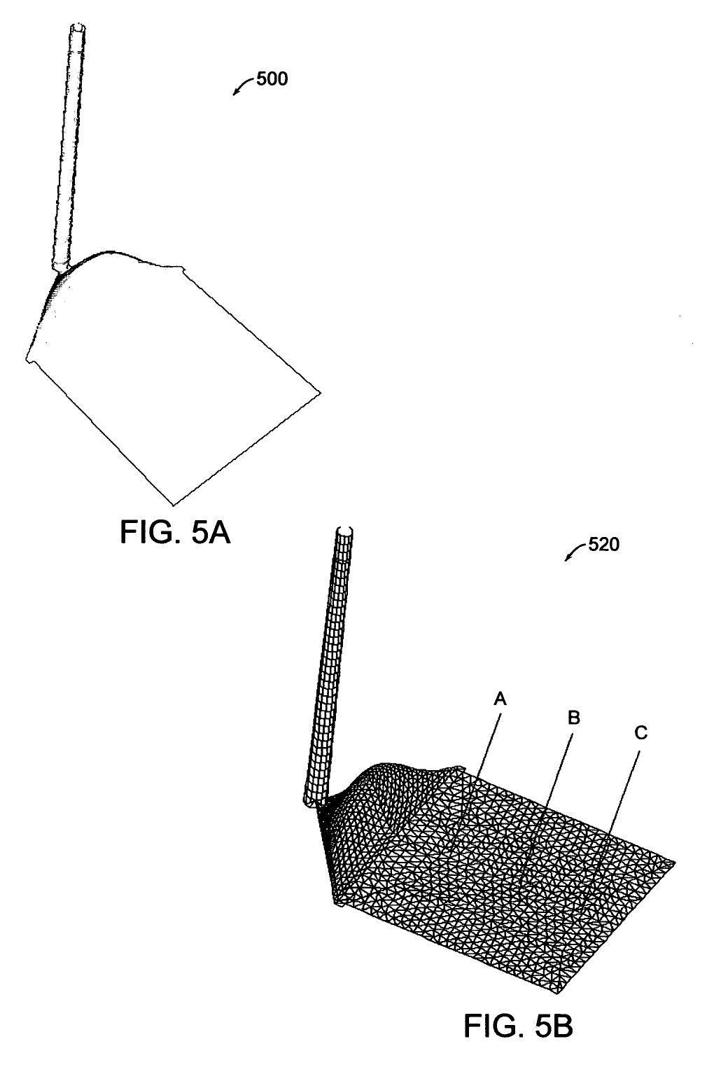

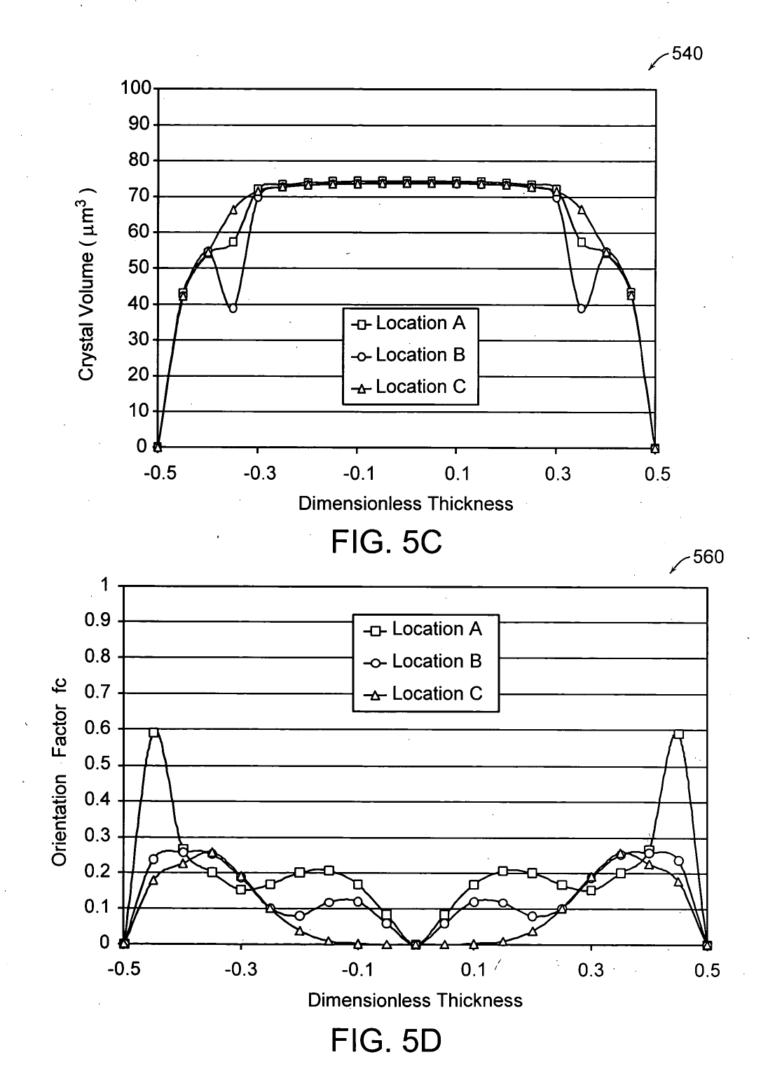

FIGS. 5A and 5B show an example application of the method of FIG. 1 for predicting a morphological characterization of crystalline structures within an injection-molded part, where the morphological characterization accounts for the process history. FIG. 5A depicts a representation 500 of an injection-molded part for which a morphological characterization is determined according to a method of the invention. The method of determining the morphological characterization for the injection-molded part of FIG. 5A follows the block diagram 100 of FIG. 1, and the morphological characterization 116 is obtained as described herein above with regard to the method of FIG. 1. FIG. 5B depicts a meshed solution domain 520 for use in the process model 104 to obtain a characterization of flow during injection molding, where the effect of flow is reflected in the morphological characterization obtained. The morphological characterization 116 includes, for example, values of crystal volume and crystal orientation determined as functions of position within the manufactured part and time. FIG. 5C is a graph 540 showing predicted crystal volume as a function of skin-core depth at points A, B, and C on the surface of the part as shown in FIG. 5B following completion of injection molding, and FIG. 5D is a graph 560 showing crystalline orientation factor, f_{c}, predicted as a function of skin-core depth at points A, B, and C, following completion of injection molding, where f_{c} is defined in Equation 42. The effect of flow and process history is reflected in the distribution of crystal volume and orientation factor shown in the graphs 540, 560 of FIGS. 5C and 5D.

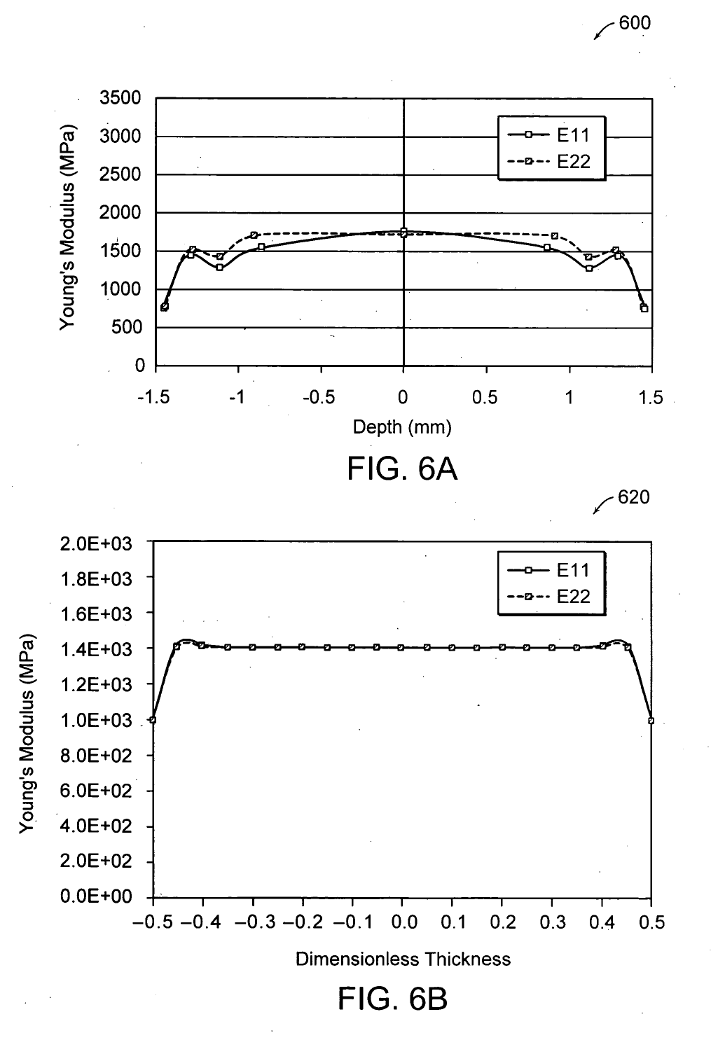

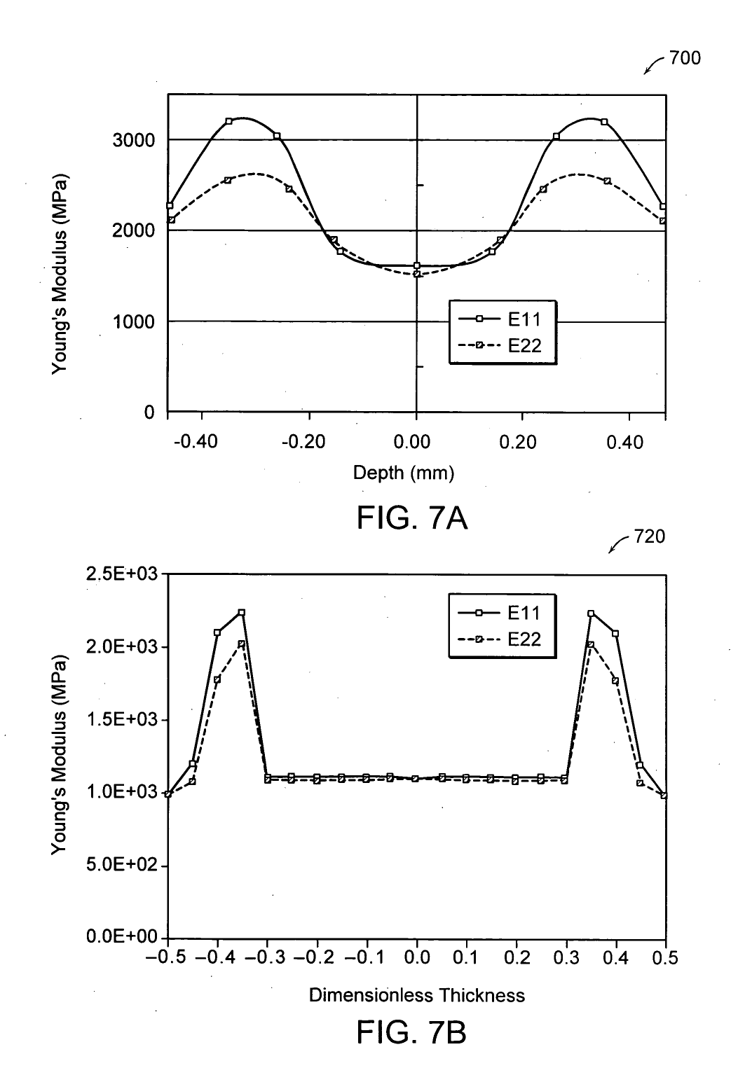

FIGS. 6A, 6B, 7A, and 7B show example applications of the method of FIG. 1 for predicting material property distributions in manufactured parts, where the predicted properties account for the processing history of the part. FIG. 6A is a graph 600 showing measured values of Young's modulus in directions normal and parallel to the flow direction, plotted as functions of depth in a 3-mm-thick injection molded part. Various samples through the thickness of the part were obtained by slicing the molded part with a microtome, and the parallel and normal Young's modulus were obtained for each sample using a tensile testing machine. FIG. 6B is a graph 620 showing predicted values of Young's modulus in the part, plotted as functions of thickness (scaled as dimensionless thickness on the x-axis), as determined for the 3-mm-thick part of FIG. 6A according to the method of FIG. 1. The calculated values predict the same trends as seen in the measured data (the modulus is relatively constant through the depth of the sample).

FIG. 7A is a graph 700 showing measured values of Young's modulus in directions normal and parallel to the flow direction, plotted as functions of depth in a 1-mm-thick injection molded part. Various samples through the thickness were obtained by slicing the molded part with a microtome, and the parallel and normal Young's modulus were obtained for each sample using a tensile testing machine. Comparing the graph 700 in FIG. 7A to the graph 600 in FIG. 6A, it is seen that the 1-mm-thick part has a higher anisotropy and a modulus that varies more through the thickness of the part than the 3-mm-thick part. Without this information, accurate mechanical analysis cannot be performed. FIG. 7B is a graph 720 showing predicted values of Young's modulus in the 1-mm-thick part as functions of thickness (scaled as dimensionless thickness on the x-axis), as determined according to the method of FIG. 1. The calculated values predict the same trends as the measured data. The effect of processing has been accounted for in predicting the Young's modulus, and the predicted values may be used for more accurate structural analysis of the injection-molded part. The improved structural analysis enables an improved method of designing plastic parts and an improved method of developing processes by which plastic parts are manufactured.

FIG. 8 depicts output of an application of the method for performing a warpage analysis of an injection-molded part, where the output is represented as a deflection map 800 corresponding to the warpage prediction at a given time during a post-molding (i.e. cooling) process. The deflection map 800 of FIG. 8 shows the calculated deformation of the component after ejection from the mold. The color scale in FIG. 8 indicates the magnitude of the deformation and shows that the edge nearest the viewer is tending to bend inward about 2 mm from its original position. As this part is designed to mate with another part to form a complete component, the warpage makes attaching the part to its mate difficult. Thus, it is desired to adjust the process conditions and/or the design of the part in such a way that will minimize warpage, subject to certain processing constraints. The warpage model allows prediction deformation as a function of process and/or design inputs, without having to actually manufacture the part.

Although a single frame of the warpage prediction is shown in the deflection map 800 of FIG. 8, the warpage is computed at a series of time steps corresponding to various times during the cooling process. A sequence of frames of warpage maps may be assembled to produce an animation of the warpage as a function of cooling time.

The method used to predict deflection in the example of FIG. 8 follows the block diagram 300 of FIG. 3. The method traces the changing morphology and changing properties of the part material during the post-molding process, and the predicted properties are used as input in the warpage analysis constitutive model 304. The constitutive model 304 is adapted from co-owned International (PCT) Patent Application No. PCT/AU00/01242, published as International Publication Number WO 01/29712, the specification of which is hereby incorporated by reference in its entirety. Further information regarding development of warpage analysis constitutive models is provided in Zheng et al, “Thermoviscoelastic simulation of thermally and pressure-induced stresses in injection moulding for the prediction of shrinkage and warpage for fibre-reinforced thermoplastics,” J. Non-Newtonian Fluid Mech. 84 (1999) 159-190, and in Fan et al., “Warpage analysis of solid geometry,” Society of Plastics Engineers, Inc., ANTEC 2000 Conference Proceedings, May 7-11, 2000, Orlando, Fla., Volume I-Processing.

The step of material property prediction 118 in the method of FIG. 3, as applied in the example of FIG. 8, includes the stress-strain relationship expressed in Equation 45 as follows:

$${σ}_{ij} = {\int }_{0}^{t} \underline{{c}_{ijkl}} ( ξ ( t ) - ξ ( {t}^{′} ) ) ( \frac{\partial {ϵ}_{kl}}{\partial {t}^{′}} - \underline{{α}_{kl}} \frac{\partial T}{\partial {t}^{′}} ) ⅆ {t}^{′} \qquad ( 45 )$$

where cᵢⱼₖₗ is the viscoelastic relaxation modulus and aₖₗ is the coefficient of expansion, predicted according to the methods described herein; and where ξ(t) is a pseudo-time scale given by the integral of (1/a₎dt′ from t′=0 to t, and a_{T} is the time-temperature shift factor. Residual stress distribution is determined at each of a series of time steps throughout the post-molding process by solving Equation 45, and the values of residual stress distribution are used in a structural analysis model 304 to determine deformation of the part at each time step. In an alternate embodiment, Equation 45 is not used; instead, it is assumed the material is viscous elastic, the elasticity is ignored, and the modulus is predicted as a function of crystallinity and temperature.

FIG. 9 is a graph 900 showing measured values of shrinkage as functions of time in directions normal and parallel to the flow direction for a given injection-molded part. In the example of FIG. 9, the parallel shrinkage changes significantly, whereas the perpendicular shrinkage is relatively constant over time. The graph 900 demonstrates that shrinkage varies as a function of time after molding, and it is therefore important to account for the time-dependence in a model for shrinkage of a manufactured part. Methods of the invention can be used, for example, to predict shrinkage as a function of the changing morphology during a post-molding (i.e. cooling and/or reheating) stage of an injection molding process.

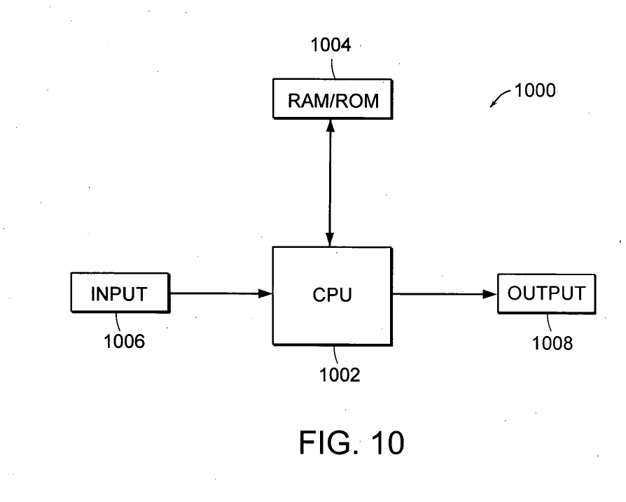

FIG. 10 depicts a computer hardware apparatus 1000 suitable for use in carrying out any of the methods described herein. The apparatus 1000 may be a portable computer, a desktop computer, a mainframe, or other suitable computer having the necessary computational speed and accuracy to support the functionality discussed herein. The computer 1000 typically includes one or more central processing units 1002 for executing the instructions contained in the software code which embraces one or more of the methods described herein. Storage 1004, such as random access memory and/or read-only memory, is provided for retaining the code, either temporarily or permanently, as well as other operating software required by the computer 1000. Permanent, non-volatile read/write memory such as hard disks are typically used to store the code, both during its use and idle time, and to store data generated by the software. The software may include one or more modules recorded on machine-readable media such as magnetic disks, magnetic tape, CD-ROM, and semiconductor memory, for example. Preferably, the machine-readable medium is resident within the computer 1000. In alternative embodiments, the machine-readable medium can be connected to the computer 1000 by a communication link. For example, a user of the software may provide input data via the internet, which is processed remotely by the computer 1000, and then simulation output is sent to the user. In alternative embodiments, one can substitute computer instructions in the form of hardwired logic for software, or one can substitute firmware (i.e., computer instructions recorded on devices such as PROMs, EPROMs, EEPROMs, or the like) for software. The term machine-readable instructions as used herein is intended to encompass software, hardwired logic, firmware, object code, and the like. The computer 1000 is preferably a general purpose computer. The computer 1000 can be, for example, an embedded computer, a personal computer such as a laptop or desktop computer, a server, or another type of computer that is capable of running the software, issuing suitable control commands, and recording information. The computer 1000 includes one or more input devices 1006, such as a keyboard and disk reader for receiving input such as data and instructions from a user, and one or more output devices 1008, such as a monitor or printer for providing simulation results in graphical and other formats. Additionally, communication buses and I/O ports may be provided to link all of the components together and permit communication with other computers and computer networks, as desired.

### Equivalents

While the invention has been particularly shown and described with reference to specific preferred embodiments, it should be understood by those skilled in the art that various changes in form and detail may be made therein without departing from the spirit and scope of the invention as defined by the appended claims.

What is claimed is:

1. A method for predicting a value of a property of processed material, the method comprising the steps of:
(a) providing a process description comprising at least one governing equation;
(b) obtaining a characterization of a flow of a material using the process description;
(c) obtaining a morphological characterization of the material using the characterization of the flow of the material; and
(d) predicting a value of a property of the material using the morphological characterization.

2. The method of claim 1, wherein the process description comprises a representation of an injection molding process.

3. The method of claim 1, wherein the process description comprises a representation of at least one member of the group consisting of an extrusion process, a blow molding process, a vacuum forming process, a spinning process, and a curing process.

4. The method of claim 1, wherein the at least one governing equation comprises conservation of mass, conservation of momentum, and conservation of energy equations.

5. The method of claim 1, wherein step (d) comprises predicting an elastic modulus of the material.

6. The method of claim 5, wherein the elastic modulus is one of the group consisting of a longitudinal Young's modulus, a transverse Young's modulus, an in-plane shear modulus, an out-plane shear modulus, and a plane-strain bulk modulus.

7. The method of claim 1, wherein step (d) comprises predicting a complex modulus of the material.

8. The method of claim 7, further comprising the step of:
(e) predicting a value of a property of the material from the complex modulus.

9. The method of claim 1, wherein step (d) comprises predicting at least one member of the group consisting of a mechanical property, a thermal property, and an optical property.

10. The method of claim 1, wherein step (d) comprises predicting at least one of a thermal expansion coefficient, a thermal conductivity, a bulk modulus, and a sound speed.

11. The method of claim 1, wherein step (d) comprises predicting at least one of clarity, opaqueness, surface gloss, color variation, birefringence, and refractive index.

12. The method of claim 1, wherein step (d) comprises predicting at least one component of a stress tensor.

13. The method of claim 12, wherein the stress tensor comprises a measure of flow-induced stress.

14. The method of claim 1, wherein the morphological characterization comprises at least one component of a conformation tensor.

15. The method of claim 1, wherein the morphological characterization comprises at least one component of an orientation tensor.

16. The method of claim 1, wherein the morphological characterization comprises a measure of crystallinity.

17. The method of claim 16, wherein the measure of crystallinity is a measure of relative crystallinity.

18. The method of claim 1, wherein step (c) comprises obtaining the morphological characterization using a description of crystallization kinetics of the material.

19. The method of claim 18, wherein the description of crystallization kinetics of the material comprises a dimensionality exponent.

20. The method of claim 18, wherein the description of crystallization kinetics of the material comprises a description of flow-induced free energy change.

21. The method of claim 18, wherein the description of crystallization kinetics of the material comprises a description of flow-induced nucleation.

22. The method of claim 1, wherein step (c) comprises obtaining the morphological characterization using a two-phase description of the material.

23. The method of claim 22, wherein the two-phase description comprises at least one of a crystallization kinetics model, an amorphous phase model, and a semi-crystalline phase model.

24. The method of claim 22, wherein the two-phase description comprises a crystallization kinetics model, an amorphous phase model, and a semi-crystalline phase model.

25. The method of claim 22, wherein the two-phase description comprises a viscoelastic constitutive equation that describes an amorphous phase.

26. The method of claim 25, wherein the viscoelastic constitutive equation comprises a FENE-P dumbbell model.

27. The method of claim 25, wherein the viscoelastic constitutive equation comprises at least one of an extended POM-POM model and a POM-POM model.

28. The method of claim 25, wherein the viscoelastic constitutive equation comprises at least one of a Giesekus model and a Phan-Thien Tanner model.

29. The method of claim 22, wherein the two-phase constitutive description comprises a rigid dumbbell model that describes a semi-crystalline phase.

30. The method of claim 1, further comprising the step of:
(e) performing a structural analysis of a product made from the processed material using the value of the property of the material.

31. The method of claim 30, wherein step (e) comprises predicting warpage of the product.

32. The method of claim 30, wherein step (e) comprises predicting shrinkage of the product.

33. The method of claim 30, wherein step (e) comprises predicting how the product reacts to a force.

34. The method of claim 30, wherein step (e) comprises predicting at least one of the group consisting of crack propagation, creep, and wear.

35. The method of claim 30, wherein step (e) comprises predicting at least one member of the group consisting of impact strength, mode of failure, mode of ductile failure, mode of brittle failure, failure stress, failure strain, failure modulus, failure flexural modulus, failure tensile modulus, stiffness, maximum loading, and burst strength.

36. The method of claim 1, wherein obtaining the flow characterization comprises using a dual domain solution method.

37. The method of claim 1, wherein obtaining the flow characterization comprises using a hybrid solution method.

38. The method of claim 1, wherein step (b) is performed after each of a plurality of time steps associated with a solution of the at least one governing equation in step (a).

39. The method of claim 1, wherein steps (b) and (c) are performed after each of a plurality of time steps associated with a solution of the at least one governing equation in step (a).

40. The method of claim 1, wherein steps (b), (c), and (d) are performed after each of a plurality of time steps associated with a solution of the at least one governing equation in step (a).

41. The method of claim 1, wherein step (c) comprises performing one or more crystallization experiments to determine one or more parameters used to obtain the morphological characterization.

42. The method of claim 1, wherein step (c) comprises performing one or more crystallization experiments to determine a crystal growth rate of the material under quiescent conditions.

43. The method of claim 1, wherein step (c) comprises performing one or more crystallization experiments to determine a half-crystallization time.

44. The method of claim 1, wherein step (c) comprises performing one or more experiments to determine at least one of a relaxation spectrum and a time-temperature shift factor.

45. A method for performing a structural analysis of a manufactured part, the method comprising the steps of:
(a) providing a process description comprising at least one governing equation;
(b) obtaining a characterization of a flow of a material using the process description;
(c) obtaining a morphological characterization of the material using the characterization of the flow of the material;
(d) predicting a value of a property of the material using the morphological characterization; and
(e) performing a structural analysis of a part made from the material using the predicted value of the property.

46. The method of claim 45, wherein step (e) comprises creating a structural analysis constitutive model.

47. The method of claim 45, wherein step (e) comprises predicting a response of the part to a load.

48. The method of claim 45, wherein step (e) comprises predicting warpage of the part.

49. The method of claim 45, wherein step (e) comprises predicting at least one member of the group consisting of warpage, shrinkage, crack propagation, creep, wear, lifetime, and failure.

50. A method for designing a part, the method comprising the steps of:
(a) providing a test design of a part, wherein the part is made from a material;
(b) providing a process description comprising at least one governing equation applied within a volume, wherein the volume is based on the test design of the part;
(c) obtaining a characterization of a flow of the material using the process description;
(d) obtaining a morphological characterization of the material using the characterization of the flow of the material;
(e) predicting a value of a property of the material using the morphological characterization;
(f) using the value of the property to evaluate a measure of part performance; and
(g) determining whether the measure of part performance satisfies a predetermined criterion.

51. The method of claim 50, wherein the method further comprises the step of:
(h) modifying the test design in the event that the measure of part performance does not satisfy the predetermined criterion.

52. A method for designing a manufacturing process, the method comprising the steps of:
(a) providing a test set of inputs for a process for manufacturing a product from a material;
(b) providing a description of the process, the description comprising at least one governing equation;
(c) obtaining a characterization of a flow of the material using the description of the process and the test set of inputs;
(d) obtaining a morphological characterization of the material using the characterization of the flow of the material;
(e) predicting a value of a property of the material using the morphological characterization;
(f) using the value of the property to evaluate a measure of product performance; and
(g) determining whether the measure of product performance satisfies a predetermined criterion.

53. An apparatus for predicting a value of a property of processed material, the apparatus comprising:
(a) a memory that stores code defining a set of instructions; and
(b) a processor that executes the instructions thereby to:
(i) obtain a characterization of flow of a material using a process description comprising at least one governing equation;
(ii) obtain a morphological characterization of the material using the characterization of flow of the material; and
(iii) predict a value of a property of the material using the morphological characterization.

54. A method for predicting a value of a property of processed material, the method comprising the steps of:
(a) providing a process description comprising at least one governing equation;
(b) obtaining a characterization of a flow of a material using the process description;
(c) providing a two-phase description of the material, wherein the description is based in part on the characterization of the flow of the material;
(d) obtaining a morphological characterization of the material using the two-phase description; and
(e) predicting a value of a property of the material using the morphological characterization.

55. The method of claim 54, wherein the material undergoes a change of phase during processing.

56. The method of claim 54, wherein the two-phase description comprises an amorphous phase model and a semi-crystalline phase model.

57. A method for simulating fluid flow within a mold cavity, the method comprising the steps of:
(a) providing a representation of a mold cavity into which a material flows;
(b) defining a solution domain based on the representation; and
(c) solving for a process variable in the solution domain at a time t using at least one governing equation, wherein step (c) comprises the substep of using a morphological characterization of the material in solving the at least one governing equation.

58. The method of claim 57, wherein the substep of using a morphological characterization of the material in solving the at least one governing equation comprises determining a viscosity of the material based at least in part on the morphological characterization of the material.

59. The method of claim 57, wherein the substep of using a morphological characterization of the material in solving the at least one governing equation comprises determining a viscosity of the material based at least in part on the morphological characterization of the material at a time prior to the time t.

60. A method for predicting a morphological characteristic of structures within a manufactured part, the method comprising the steps of:
(a) providing a model of at least one stage of a manufacturing process;
(b) obtaining a characterization of flow of a material, where the flow occurs during the at least one stage of the manufacturing process; and
(c) predicting a morphological characterization of structures within at least a portion of a manufactured part using the flow characterization.

61. The method of claim 60, wherein step (c) comprises predicting an orientation of crystallites within the manufactured part.

62. The method of claim 60, wherein step (c) comprises predicting a size distribution of crystallites within the manufactured part.

63. The method of claim 60, wherein step (c) comprises predicting a crystal volume as a function of position within the manufactured part.

64. The method of claim 60, wherein step (c) comprises predicting an orientation factor as a function of position within the manufactured part.

65. The method of claim 60, wherein step (c) comprises predicting the morphological characterization using a description of crystallization kinetics of the material.

66. The method of claim 65, wherein the description of crystallization kinetics comprises an expression for excess free energy.

67. The method of claim 60, wherein the manufacturing process is an injection molding process.

68. The method of claim 1, wherein step (d) comprises predicting material property values at a plurality of locations within a part made from the processed material.

69. The method of claim 1, wherein step (d) comprises predicting material property values of a part having an arbitrary geometry, where the part is made from the processed material.

70. The method of claim 3, wherein the process description comprises a representation of at least one member of the group consisting of a profile extrusion process, a blow film extrusion process, and a film extrusion process.

71. The method of claim 45, wherein step (e) comprises predicting a response of the part to a thermal load.
